(19) United States
(12) Patent Application Publication
(10) Pub. No.: US 2024/0405404 A1
(43) Pub. Date: Dec. 5, 2024

(54) CONNECTION TERMINAL AND ANTENNA DEVICE

(71) Applicant: YOKOWO CO., LTD., Chiyoda-ku, Tokyo (JP)

(72) Inventors: Tsuyoshi KOMORI, Tomioka-Shi, Gunma (JP); Shunsuke SUZUKI, Tomioka-Shi, Gunma (JP)

(73) Assignee: YOKOWO CO., LTD., Chiyoda-ku, Tokyo (JP)

(21) Appl. No.: 18/691,508

(22) PCT Filed: Feb. 25, 2022
(86) PCT No.: PCT/JP2022/007824

§ 371 Date: Mar. 13, 2024

Related U.S. Application Data
(60) Provisional application No. 63/272,791, filed on Oct. 28, 2021.

(51) Int. Cl. H01Q 1/12; H01Q 1/36; H01Q 1/48; H01Q 1/50

(52) U.S. Cl. CPC H01Q 1/12; H01Q 1/36; H01Q 1/48; H01Q 1/50

(57) ABSTRACT

A connection terminal configured to connect an antenna element to a substrate, the connection terminal includes: a holding part configured to hold a holdable part of the antenna element inserted from one surface of the substrate into a through-hole formed in the substrate, at a position on a side of another surface of the substrate opposite to the one surface; and a support part configured to support the holding part against the substrate.

### TECHNICAL FIELD

The present disclosure relates to a connection terminal and an antenna device.

### BACKGROUND ART

Patent Literature 1 discloses an antenna device in which an antenna substrate is held above a main substrate.

### CITATION LIST

### Patent Literature

[PTL 1] Japanese Patent Application Publication No. 2021-034750

### SUMMARY OF INVENTION

### Technical Problem

An example of an object of the present disclosure is to reduce the height of an antenna device.

### Solution to Problem

An aspect of the present disclosure is a connection terminal configured to connect an antenna element to a substrate, the connection terminal comprising: a holding part configured to hold a holdable part of the antenna element inserted from one surface of the substrate into a through-hole formed in the substrate, at a position on a side of another surface of the substrate opposite to the one surface; and a support part configured to support the holding part against the substrate.

Another aspect of the present disclosure is an antenna device comprising: the connection terminal; the substrate to which the connection terminal is attached; the antenna element connected to the substrate through the connection terminal; and a ground portion configured to function as a ground of the antenna element.

### Advantageous Effects of Invention

According to an aspect to the present disclosure, it is possible to reduce the height of an antenna device.

### BRIEF DESCRIPTION OF DRAWINGS

FIG. 1 illustrates an example of a perspective view of an antenna device 100.

FIG. 2 illustrates an example of a top view of an antenna device 100 with a case 14 removed.

FIG. 3 illustrates an example of an exploded perspective view of a substrate 12, a connection terminal 15a, and a feeding portion 31 of an antenna element 13.

FIG. 4A is a top view of a substrate 12, and FIG. 4B is a sectional side view of a connection terminal 15a engaged with a substrate 12, with a feeding portion 31 inserted thereinto.

FIG. 5 illustrates an example of an exploded perspective view of a substrate 12, a connection terminal 101, and a feeding portion 31 of an antenna element 13.

FIG. 6 is an example of a side view illustrating comparison between a case where an antenna element 13 is connected to a substrate 12 through a connection terminal 101 and a case where an antenna element 13 is connected to a substrate 12 through a connection terminal 15a.

FIG. 7 illustrates an example of an exploded perspective view of a substrate 12, a connection terminal 15b, and a feeding portion 31 of an antenna element 13.

FIG. 8A is an example of an exploded perspective view and FIG. 8B is an example of a sectional side view, illustrating a substrate 12, a connection terminal 15c, and a feeding portion 31 of an antenna element 13.

FIG. 9A is an example of an exploded perspective view and FIG. 9B is an example of a sectional side view, illustrating a substrate 12, a connection terminal 15d, and a feeding portion 31 of an antenna element 13.

FIG. 10A is an example of an exploded perspective view and FIG. 10B is an example of a sectional side view, illustrating a substrate 12, a connection terminal 15e, and a feeding portion 31 of an antenna element 13.

FIG. 11 illustrates an example of a sectional side view of a connection terminal 15a having a first length d1 from a contact part 71 to a contact part 72 through at least a part of a holding part 51 and at least a part of a support part 52.

FIG. 12 illustrates an example of the VSWR of an antenna device 100 as a first length d1 changes.

FIG. 13 illustrates an example of a sectional side view of a connection terminal 15a having a second length d2 and a third length d3 from a contact part 71 to an open end through at least a part of a holding part 51 and a support part 52.

FIG. 14 illustrates an example of the VSWR of an antenna device 100 as a second length d2 and a third length d3 change.

FIG. 15A is a perspective view of a connection terminal 15a attached to a substrate 12, FIG. 15B is a perspective view of the connection terminal 15a holding an antenna element 13, and FIG. 15C is a conceptual diagram of a fifth length d5.

FIG. 16 illustrates an example of the VSWR of an antenna device 100 as a fifth length d5 changes.

FIG. 17 illustrates an example of a sectional side view of a substrate 12, a connection terminal 101, and a feeding portion 31 of an antenna element 13.

FIG. 18 illustrates an example of the VSWRs of a connection terminal 15a and a connection terminal 101.

FIG. 19A is an example of a perspective view illustrating a connection terminal 15c when a support part 58 of a connection terminal 15c is unfolded, and FIG. 19B is an example of a sectional side view illustrating the connection terminal 15c.

FIG. 20A is an example of a perspective view, FIG. 20B is an example of a top view, and FIG. 20C is an example of a sectional side view, illustrating a connection terminal 15d.

FIG. 21A is an example of a perspective view, FIG. 21B is an example of a top view, and FIG. 21C is an example of a sectional side view, illustrating a connection terminal 15e.

FIG. 22 illustrates an example of a perspective view illustrating an antenna element 13.

FIG. 23A illustrates an arrangement example in a top view of a substrate 12 where a feeding portion 31 is arranged at a corner of a substrate 12, the arrangement example being where a long side of an antenna element 13 is aligned with a long side of the substrate 12, and FIG. 23B illustrates an arrangement example, in the top view thereof, where the long side of the antenna element 13 is aligned with a short side of the substrate 12.

FIG. 24 illustrates an example of the VSWR of an antenna device 100 in each of arrangement examples illustrated in FIGS. 23A and 23B.

FIG. 25A illustrates an arrangement example in a top view of a substrate 12 where a feeding portion 31 is arranged in the vicinity of the midpoint of a long side of the substrate 12, the arrangement example being where a long side of an antenna element 13 is aligned with the long side of the substrate 12, and FIG. 25B illustrates an arrangement example, in the top view thereof, where a short side of the antenna element is aligned with the long side of the substrate 12.

FIG. 26 illustrates an example of the VSWR of an antenna device 100 in each of arrangement examples illustrated in FIGS. 25A and 25B.

FIG. 27A illustrates an arrangement example in a top view of a substrate 12 with a long side of an antenna element 13 aligned with a long side of a substrate 12, the arrangement example being where a feeding portion 31 is arranged at a corner of the substrate 12, FIG. 27B illustrates an arrangement example, in the top view thereof, where the feeding portion 31 is arranged in the vicinity of the midpoint of the long side of the substrate 12, FIG. 27C illustrates an arrangement example, in the top view thereof, where the feeding portion 31 is arranged in the vicinity of the midpoint of a short side of the substrate 12, and FIG. 27D illustrates an arrangement example, in the top view thereof, where the feeding portion 31 is arranged in the vicinity of the center of the substrate 12.

FIG. 28 illustrates an example of the VSWR of an antenna device 100 in each of arrangement examples illustrated in FIGS. 27A to 27D.

FIG. 29A illustrates an arrangement example in a top view of an antenna element 13 arranged on or above a ground portion 11, the arrangement example being where at least a part of an antenna element 13 overlaps with a cutout portion 20 of a substrate 12, and FIG. 29B illustrates an arrangement example, in the top view thereof, where the entire antenna element 13 lies above the substrate 12.

FIG. 30 illustrates an example of VSWR of an antenna device 100 in each of arrangement examples illustrated in FIGS. 29A and 29B.

### DESCRIPTION OF EMBODIMENTS

At least the following matters will become apparent from the description of the present specification and the accompanying drawings.

The following describes preferred embodiments of the present disclosure with reference to the drawings. The same or equivalent components, members, and the like illustrated in the drawings are given the same reference numerals, and repetitive description is omitted as appropriate. Note that not all combinations of features described in embodiments are essential to the solution in the disclosure.

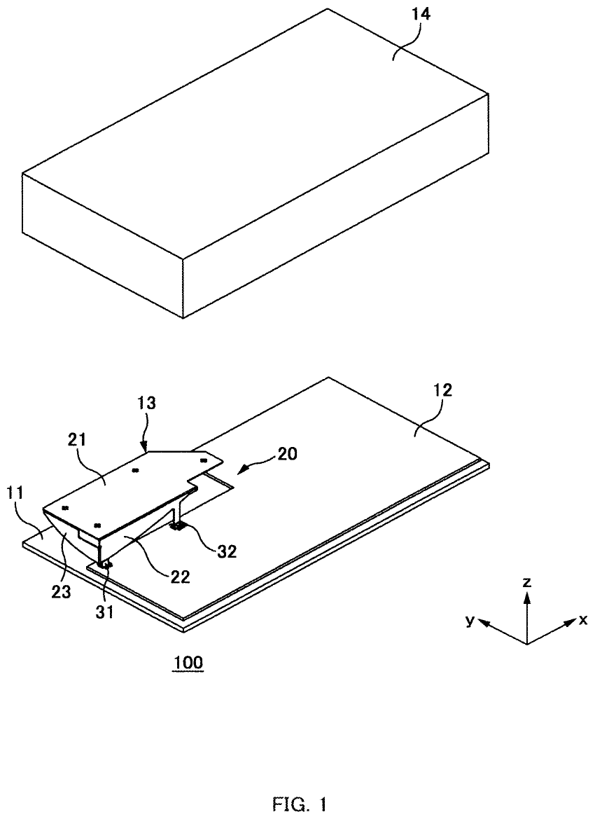

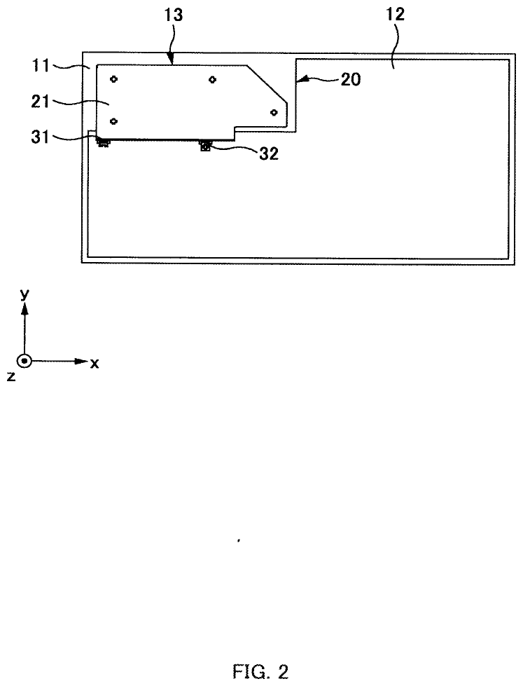

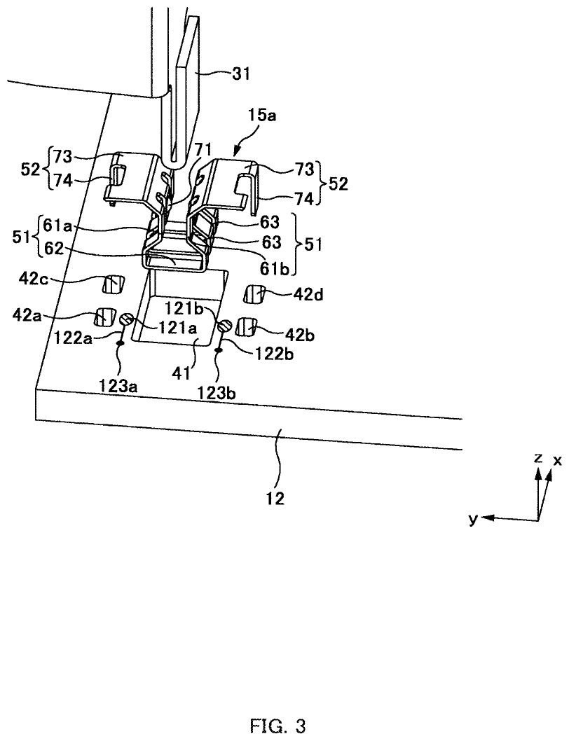

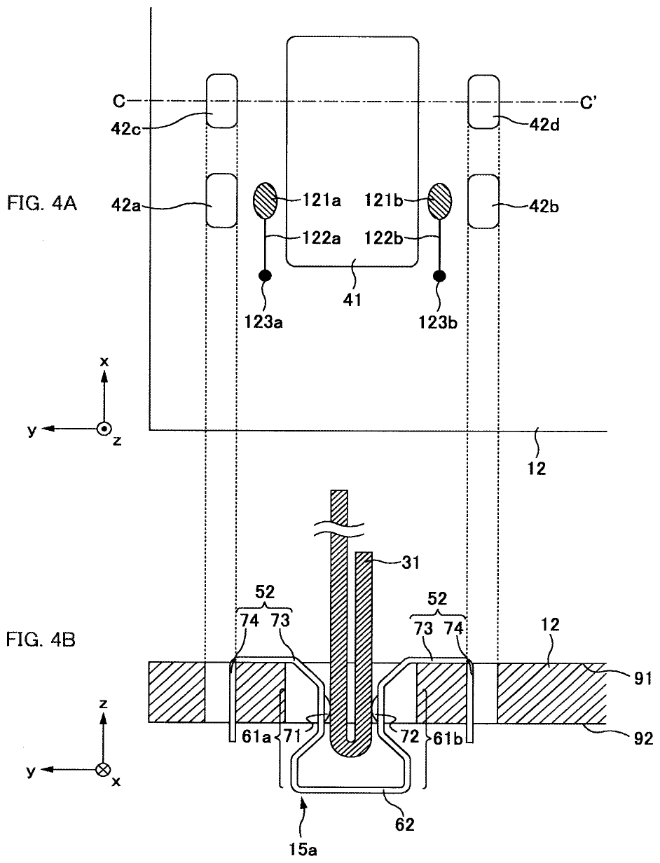

FIG. 1 illustrates an example of a perspective view of an antenna device 100. FIG. 2 is a top view of the antenna device 100 without a case 14. The antenna device 100 includes a ground portion 11, a substrate 12, an antenna element 13, the case 14, and a connection terminal 15a, which will be described later with reference to FIGS. 3 and 4.

### Definition of Directions and the Like

In FIG. 1, an x-axis is defined as a direction along the longest side of the plate-shaped ground portion 11 having a substantially rectangular shape, or a direction parallel to the long side. In an embodiment of the present disclosure, in the x-axis, a direction from a feeding portion 31 to a short-circuit portion 32, which will be described later, is referred to as +x direction (or “rightward”), a direction from the short-circuit portion 32 to the feeding portion 31 is referred to as −x direction (or “leftward”). Further, a point at which the x-axis and a short side on the −x side of the ground portion 11 (or a straight line extending from the short side) intersect is defined as the origin.

Here, a y-axis is defined as a direction along the side of the ground portion 11 extending from the origin toward the feeding portion 31 (described later) or a direction parallel to that side. A +y direction is referred to as “rearward” and a −y direction is referred to as “frontward”.

A z-axis is defined as a direction perpendicular to an x-y plane. When the z-axis is defined as such, a +z direction may be referred to as “upward” and a −z direction may be referred to as “downward”.

An upper (+z side) surface of a plate-shaped member such as the ground portion 11 may be referred to as “front surface” and a lower (−z side) surface opposite to the front surface may be referred to as “back surface”. For each member, dimension in the x direction or y direction may be referred to as “width”, and dimension in the z direction may be referred to as “height”.

Note that the definitions of the directions and the like described above are also common to those in other embodiments in the present description, unless otherwise specified.

### Overview of Antenna Device 100

Next, an overview of the antenna device 100 will be described with reference to FIGS. 1 and 2.

The antenna device 100 is an antenna device for a vehicle. The antenna device 100 according to an embodiment of the present disclosure is referred to as, for example, a Hidden antenna or a flat antenna, which is disposed between a chassis and electromagnetic wave transparent resin or glass provided in an opening formed in a roof of a vehicle. However, the antenna device 100 may be an antenna device used at a mobile body other than a vehicle.

The ground portion 11 is a metal plate-shaped member forming a bottom surface of the antenna device 100. Although the ground portion 11 is provided at the bottom surface of the antenna device 100 in an embodiment of the present disclosure, a metal body of the vehicle may be used as the ground of the antenna device 100, without providing the ground portion 11. In this case, a resin base member may be provided between the vehicle and the substrate 12 (described later) of the antenna device 100.

The ground portion 11 may also include a resin base (not illustrated) and a metal base disposed on or above the resin base (on the +z side). The metal base is, for example, a metal member processed such that various parts are attachable thereto.

In an embodiment of the present disclosure, the ground portion 11 has a substantially rectangular shape. The shape of the ground portion 11 is not limited to the substantially rectangular shape, but may be a substantially quadrilateral shape. Here, the “quadrilateral shape” includes various shapes such as a square, a rectangle, a parallelogram, a trapezoid, or a rhombus.

Note that the “substantially rectangular shape” or “substantially quadrilateral shape” also includes a shape having at least part of its corners obliquely cut off, a shape with chamfered round corner(s), and a shape with part of its sides having a cut(s) or protrusion(s). The shape of the ground portion 11 may be a shape different therefrom such as a circle, an ellipse, a semicircle, a semi-ellipse, a fan shape, a polygon, or the like, depending on the design.

The substrate 12 is a plate-shaped member at which the antenna element 13 and the like are mounted, and is disposed on or above the ground portion 11.

The substrate 12 of an embodiment of the present disclosure overlaps with the ground portion 11 and has a smaller size than the ground portion 11 in plan view of the substrate 12. Particularly, the substrate 12 of an embodiment of the present disclosure has a substantially quadrilateral cutout portion 20 in its upper left corner in FIG. 2. However, the substrate 12 may have the same shape and size as the ground portion 11 in plan view of the substrate 12.

Note that the “plan view” of the substrate 12 refers to a viewpoint when the front surface (x-y plane) of the substrate is viewed from the +z direction. In the following description, the “plan view” of the substrate 12 will be simply given the “plan view”.

The antenna element 13 is, for example, a telematics antenna element for 5G or the like, which supports frequency bands of 600 MHz to 960 MHz and 1400 to 6000 MHz. However, the antenna element 13 may also be an antenna used for different purposes such as Vehicle to Everything (V2X), AM/FM radio, Wi-Fi (registered trademark), Bluetooth (registered trademark), keyless entry, smart entry, and the like, or may also be a linear polarized antenna. Here, the antenna element 13 is electrically connected to the substrate 12 through the connection terminal 15a which will be described later.

The term “connecting” as hereinafter used includes not only “physical connecting” but also both “physical connecting” and “electrical connecting”, unless otherwise specified.

FIGS. 1 and 2 illustrate an embodiment in which only one single antenna element 13 is provided on or above the substrate 12. However, a plurality of antenna elements 13 may be provided on the substrate 12 so as to support a multi-input multi-output (MIMO) system. Alternatively, antenna elements that support different frequency bands or antenna elements used for different purposes, such as V2X, AM/FM radio, and the like, may be provided as the plurality of antenna elements 13.

The configuration and arrangement of the antenna element 13 will be described later in detail.

The case 14 covers the ground portion 11 to form an accommodation space in which the substrate 12, the antenna element 13, and the like are accommodated together with the ground portion 11. The case 14 is made of electromagnetic wave transparent synthetic resin (for example, ABS resin) and covers the antenna element 13. The provision of the case 14 to the antenna device 100 improves transportability of the antenna device 100 and facilitates mounting of the antenna device 100 to a vehicle. However, the case 14 can be omitted based on the design conditions and the like of the antenna device 100.

In an embodiment of the present disclosure, the case 14 has a substantially rectangular parallelepiped shape (box shape). However, the shape of the case 14 is not limited to the substantially rectangular parallelepiped shape, but may be a different shape depending on the conditions (space and/or the like) of an installation location at the vehicle where the antenna device 100 is to be mounted. Particularly, in an embodiment of the present disclosure, the height of the case 14 is designed such that the antenna device 100 can be disposed between the roof and chassis of the vehicle.

The case 14 is fixed to the ground portion 11 and the antenna element 13 by various joining methods such as snap-fitting, screwing, welding, and/or adhesion. However, the case 14 may be fixed to only either the ground portion 11 or the antenna element 13.

The case 14 of an embodiment of the present disclosure is made of electromagnetic wave transparent synthetic resin (for example, ABS resin) and covers the antenna element 13. However, the case 14 may be partially made of metal as long as the antenna element 13 can communicate with the outside of the vehicle through the case 14. Such a metal portion of the case 14 functions as a parasitic element that controls the directivity of the antenna device 100.

### Feeding Portion 31 and Short-Circuit Portion 32

The antenna element 13 includes a top plate portion 21 and side plate portions 22 and 23. The side plate portion 22 is provided with the feeding portion 31 and the short-circuit portion 32. Note that the details of the configuration of the antenna element 13 will be described later, and the feeding portion 31 and the short-circuit portion 32 will be briefly described here.

The feeding portion 31 and the short-circuit portion 32 are each held by the connection terminal 15a attached to the substrate 12. The feeding portion 31 receives power from the substrate 12, and the short-circuit portion 32 is connected to the ground portion 11. This causes the short-circuit portion 32 to have the same potential as the ground potential. The provision of the short-circuit portion 32 enables the antenna element 13 to operate as a folded dipole antenna.

The antenna element 13 is connected to the substrate 12, with the feeding portion 31 and the short-circuit portion 32 each being held by the connection terminal 15a. As will be described later in detail the feeding portion 31 and the short-circuit portion 32 each correspond to a “holdable part” to be held by a holding part 51 of the connection terminal 15a.

### Overview of Connection Terminal 15a

Next, the connection terminal 15a configured to connect the antenna element 13 to the substrate 12 will be described with reference to FIGS. 3 and 4. Although the connection terminal 15a that holds the feeding portion 31 will be described below, the same applies to the configuration of the connection terminal 15a that holds the short-circuit portion 32.

FIG. 3 is an example of an exploded perspective view of the substrate 12, the connection terminal 15a, and the feeding portion 31 of the antenna element 13. FIG. 4A is a top view of the substrate 12. FIG. 4B is a sectional side view of the connection terminal 15a attached to the substrate 12, with the feeding portion 31 inserted therein. Note that FIG. 4B corresponds to a cross-sectional view taken along line C-C′ in FIG. 4A.

As illustrated in FIGS. 4A and 4B, a through-hole 41 and holes 42a to 42d are formed in the substrate 12. The connection terminal 15a is attached to the substrate 12 using the through-hole 41 and the holes 42a to 42d.

The connection terminal 15a has the holding part 51 and a support part 52. The holding part 51 holds the feeding portion 31 of the antenna element 13 at a position closer to a back surface 92 than to a front surface 91 of the substrate 12. The support part 52 supports the holding part 51 against the substrate 12.

### Explanation of Holding Part 51

The holding part 51 holds the feeding portion 31 by elastically clamping the feeding portion 31.

The feeding portion 31 of the antenna element 13 has a structure in which a lower end portion is folded upward, and this folded portion is held by the holding part 51. This allows the holding part 51 to have sufficient holding strength to hold the feeding portion 31. The holding strength may also be increased by increasing the thickness of the sheet metal of the feeding portion 31.

The holding part 51 has a pair of clamping parts 61a and 61b and a coupling part 62.

The pair of clamping parts 61a and 61b elastically clamp the feeding portion 31 from the left and right sides (positive and negative sides of the y direction in FIG. 4B. As illustrated in FIG. 4B, protruding contact parts 71 and 72 to contact the feeding portion 31 are formed at opposing surfaces of the clamping parts 61a and 61b, respectively.

With the contact parts 71 and 72 being formed as such, the feeding portion 31 can be clamped from the left and right sides (positive and negative sides of the y direction in FIG. 4B) by the contact parts 71 and 72. Since the pressure of the contact parts 71 and 72 applies to the feeding portion 31 increases, the electrical connection between the connection terminal 15a and the feeding portion 31 can be further ensured and improved. It is preferable that the shortest distance between the contact part 71 and the contact part 72 (distance in the y direction in FIG. 4B) is less than or equal to the shortest distance between the position at which the feeding portion 31 contacts the contact part 71 and the position at which the feeding portion 31 contacts the contact part 72 (distance in the y direction in FIG. 4B).

The coupling part 62 couples the pair of clamping parts 61a and 61b at a position protruding below the through-hole 41 (on the back surface side of the substrate 12). In an embodiment of the present disclosure, the coupling part 62 couples the pair of clamping parts 61a and 61b at a position below (in the −z direction) the back surface 92 of the substrate 12.

Cutout portions 63 are formed in the clamping parts 61a and 61b to reduce the rigidity of the holding part 51. Too high rigidity of the holding part 51 makes it less easy to insert the feeding portion 31 of the antenna element 13 between the clamping parts 61a and 61b. In an embodiment of the present disclosure, however, since the cutout portions 63 reduce the rigidity of the holding part 51, the feeding portion 31 can be smoothly inserted between the clamping parts 61a and 61b. Note that the rigidity of the holding part 51 can be appropriately adjusted by adjusting the dimensions (width and/or length) of the cutout portions 63.

The cutout portion 63 is formed in a slit shape from the clamping part 61a through the coupling part 62 to the clamping part 62b. Although the connection terminal 15a of an embodiment of the present disclosure includes two cutout portions 63, only one cutout portion 63 may be formed, or three or more cutout portions 63 may be formed. Also, the shape of the cutout portion 63 is not limited to the slit shape. When the holding part 51 has appropriate rigidity without forming any cutout portions 63, the cutout portions 63 do not have to be formed.

The cutout portion 63 corresponds to a “first cutout portion”. The contact part 71 corresponds to a “first contact part” and the contact part 72 corresponds to a “second contact part”.

### Explanation of Support Part 52

The support part 52 supports the holding part 51 against the substrate 12, and includes a surface contact part 73 and an insertable part 74.

The surface contact part 73 is a flat portion formed so as to be continuous with each upper end of the clamping parts 61a and 61b of the holding part 51, and has its lower surface to be in contact with the front surface 91 of the substrate 12. The surface contact part 73 may have at least part of its lower surface to be in contact with the front surface 91 of the substrate 12.

The insertable part 74 is a portion that is continuous with the end of the surface contact part 73, is formed so as to bend downward, and is insertable into each of the holes 42c and 42d. Note that the insertable parts 74 are provided corresponding only to the holes 42c and 42d, and the insertable parts 74 corresponding to the holes 42a and 42b are omitted.

The holes 42c and 42d are filled with solder and the solder is solidified in advance. When attaching the connection terminal 15a to the substrate 12, the insertable parts 74 are inserted with the solder melted and then the solder is solidified again, thereby fixing the insertable parts 74 in the holes 42c and 42d, respectively. With the surface contact parts 73 being in surface contact with the front surface 91 of the substrate 12 as described above, the insertable parts 74 can be inserted into the holes 42c and 42d and fixed therein, respectively, in a state where the posture of the connection terminal 15a is stabilized.

Here, the insertable parts 74 are fixed, with the solder filled and solidified, in the holes 42c and 42d, however, fixing with solder is not performed in the holes 42a and 42b, at which the insertable parts 74 are omitted. This is because it is possible to ensure sufficient bonding strength to the substrate 12 on the −x side relative to the contact parts 71 and 72 by solder-bonding the surface contact part 73 through solder connection parts 121a and 121b to be described below. However, the insertable parts 74 may also be provided on the side of the holes 42a and 42b, and the insertable parts 74 may be solder-bonded in the holes 42a and 42b.

Between the connection terminal 15a of an embodiment of the present disclosure and the front surface 91 of the substrate 12, the connection parts 121a and 121b are provided by solder bonding. At the front surface 91 of the substrate 12, patternings 122a and 122b are also provided to join the connection parts 121a and 121b and ports 123a to 123b of the substrate 12, respectively.

The connection parts 121a and 121b may be provided at different locations of the support part 52, depending on the design conditions of the antenna device 100, as long as at least a part of the support part 52 and the front surface of the substrate 12 are connected. For example, the support part 52 may have the connection parts 121a and 121b on the back surface 92 side of the substrate 12, and may be connected to the substrate on the back surface 92 side of the substrate 12.

### Overview of Connection Terminal 101 of Comparative Example

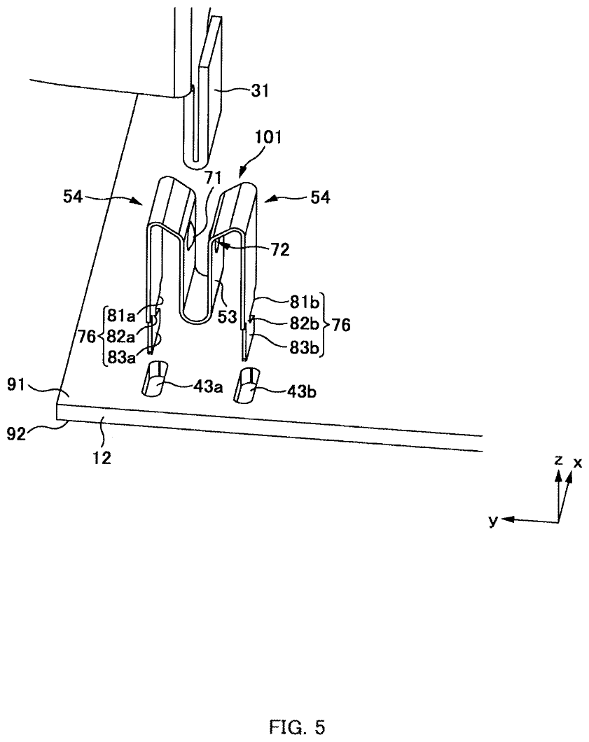

FIG. 5 illustrates an example of an exploded perspective view of the substrate 12, a connection terminal 101, and the feeding portion 31 of the antenna element 13. The connection terminal 101 has an M-shape in side cross section. The connection terminal 101 includes: a holding part 53 that clamps and holds the feeding portion 31 of the antenna element 13; and a support part 54 that supports the holding part 53 against the substrate 12.

The connection terminal 101 is attached to the substrate 12 in a state of protruding upward from the front surface 91 of the substrate 12. The holding part 53 holds the feeding portion 31 of the antenna element 13 above the front surface 91 of the substrate 12. The holding part 53 has contact parts 71 and 72, and contacts the feeding portion 31 of the antenna element 13 at the contact parts 71 and 72.

As such, the feeding portion 31 of the antenna element 13 is connected to the connection terminal 101 through the contact parts 71 and 72.

The support part 54 has an insertable part 76 at its lower end. The insertable parts 76 are inserted into holes 43a and 43b formed in the substrate 12. The insertable parts 76 have locking parts 81a and 81b, bent parts 82a and 82b, and connection parts 83a and 83b. The bent parts 82a and 82b are provided adjacent to the distal ends of the locking parts 81a and 81b, and the connection parts 83a and 83b are provided further adjacent to the distal ends of the locking parts 81a and 81b.

The locking parts 81a and 81b engage with the outer edges of the holes 43a and 43b at the front surface 91 of the substrate 12 when the insertable parts 76 are inserted into the holes 43a and 43b, thereby holding the connection terminal 101 with respect to the holes 43a and 43b.

After the insertable part 76 is inserted into the hole 43a, the bent parts 82a and 82b are bent such that the connection parts 83a and 83b come into contact with the back surface 92 of the substrate 12.

In a state of being in contact with the back surface 92 of the substrate 12, the connection parts 83a and 83b are electrically connected to the patterning at the back surface 92 by solder bonding and/or the like. This electrically connects the antenna element 13 to the patterning at the back surface 92 of the substrate 12 through the connection terminal 101.

Comparison between Connection Terminal 15a and Connection Terminal 101

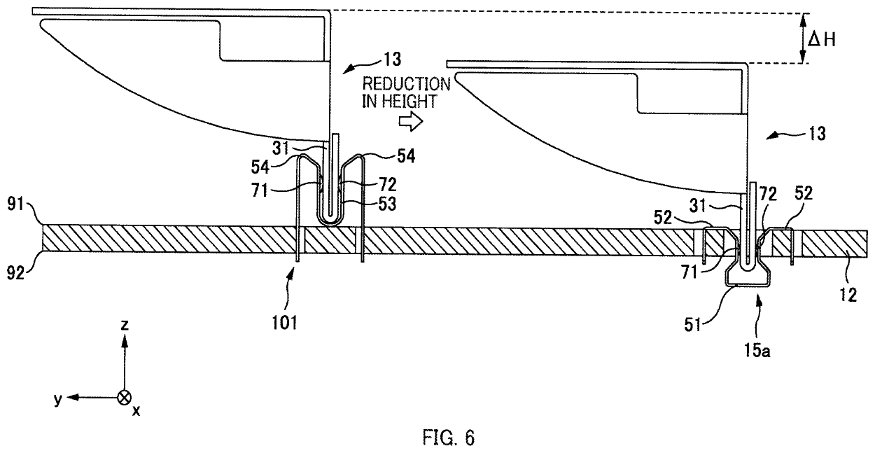

FIG. 6 is a side view illustrating comparison between the case where the antenna element 13 is connected to the substrate 12 through the connection terminal 101 and the case where the antenna element 13 is connected to the substrate 12 through the connection terminal 15a.

As described above, the connection terminal 15a holds the feeding portion 31 of the antenna element 13 below the front surface 91 of the substrate 12. On the other hand, the connection terminal 101 holds the feeding portion 31 of the antenna element 13 above the front surface 91 of the substrate 12.

Thus, the height of the antenna element 13 held by the connection terminal 15a from the substrate 12 is lower than that of the antenna element 13 held by the connection terminal 101 by ΔH given in FIG. 6. Note that the portion of the connection terminal 15a that protrudes from the back surface 92 of the substrate 12 is positioned between the substrate 12 and the ground portion 11. Accordingly, the use of the connection terminal 15a of an embodiment of the present disclosure makes it possible to reduce the height of the antenna device 100 by ΔH. Such a reduction in height of the antenna element 13 from the substrate 12 enables the antenna element 13 to be stably held by the substrate 12 against vibrations and the like.

Modifications of the connection terminal according to the present disclosure will be described below. In the following modifications, differences from the above connection terminal 15a will be mainly described. The modifications illustrate configurations in which no cutout portions are formed in the holding part of the connection terminal. However, cutout portions may be formed to reduce the rigidity of the holding part, as in the connection terminal 15a described above.

### Modification 1 of Connection Terminal 15 (Connection Terminal 15b)

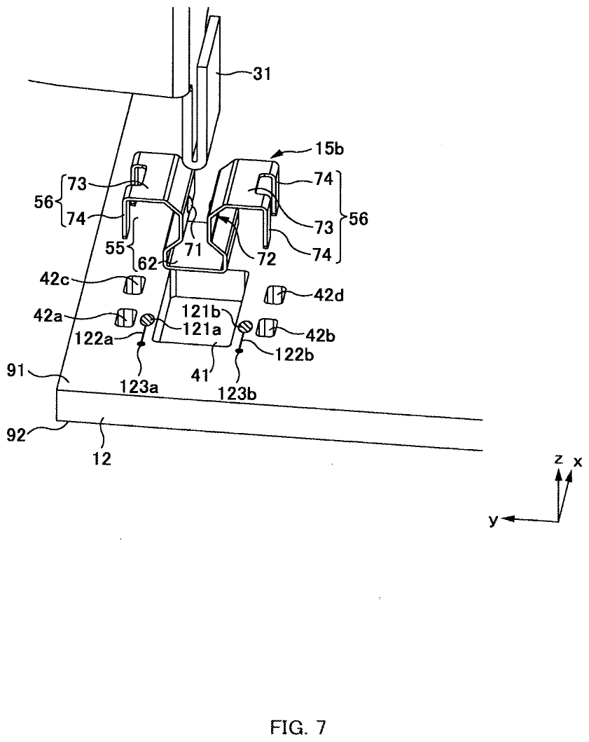

FIG. 7 illustrates an example of an exploded perspective view of the substrate 12, a connection terminal 15b, and the feeding portion 31 of the antenna element 13. The connection terminal 15b includes a holding part 55 and a support part 56. The holding part 55 and the support part 56 are connected to the substrate 12, as in the connection terminal 15a.

The insertable parts 74 corresponding to the holes 42a and 42b are omitted in the connection terminal 15a. Meanwhile, the insertable parts 74 to be inserted into the holes 42a and 42b are provided in this modification.

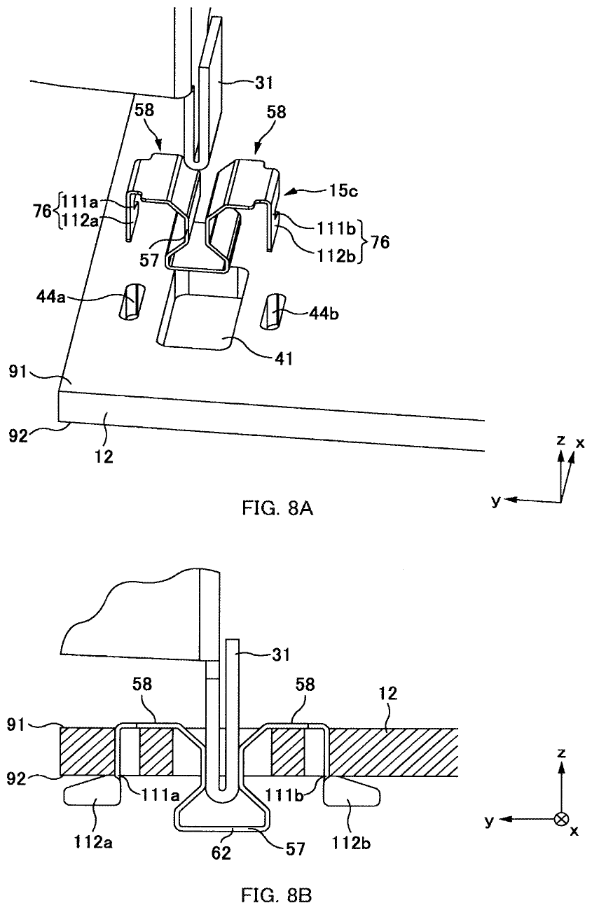

In the following description of modifications 2 to 4 illustrated in FIGS. 8 to 10, illustrations of the connection parts 121a and 121b, the patternings 122a and 122b, and the ports 123a and 123b are omitted, and connection relationships will be described later in detail.

### Modification 2 of Connection Terminal 15 (Connection Terminal 15c)

FIG. 8A is an example of an exploded perspective view and FIG. 8B is an example of a sectional side view, illustrating the substrate 12, a connection terminal 15c, and the feeding portion 31 of the antenna element 13.

The connection terminal 15c has a holding part 57 and a support part 58. The holding part 57 has no contact parts 71 and 72 that protrude from the clamping parts. In the holding part 57, regions to come into contact with the feeding portion 31 when clamping the feeding portion 31 correspond to the contact parts 71 and 72. However, the contact parts 71 and 72 that protrude from the clamping parts may be provided, and this also applies to modifications 3 and 4 which will be described below.

The support part 58 has insertable parts 76, which are to be inserted into holes 44a and 44b. The insertable parts 76 have twist parts 111a and 111b that protrude from the back surface 92 of the substrate 12 when inserted into the holes 44a and 44b, and knob parts 112a and 112b.

First, the insertable parts 76 of the support part 58 are inserted into the holes 44a and 44b, respectively. Next, the twist part 111a of the support part 58 is twisted about ¼ turn in the direction of a right-hand screw with respect to the +z direction (that is, counterclockwise in plan view) with the z-axis as the rotation axis. In this event, the twist part 111a may be twisted while holding the knob part 112a. Specifically, the knob part 112a is rotated such that the tip of the knob part 112a directed in the +x direction is directed in the +y direction.

Similarly, the twist part 111b is twisted about¼ turn in the direction of a left-hand screw with respect to the +z direction (that is, clockwise in plan view) with the z-axis as the rotation axis. In this event, the twist part 111a may be twisted while holding the knob part 112b. Specifically, the knob part 112b is rotated such that the tip of the knob part 112b directed in the +x direction is directed in the −y direction. The connection terminal 15c is thus clinch-fixed to the substrate 12.

Further, the knob parts 112a and 112b are connected to the back surface 92 of the substrate 12 by manual solder bonding. Note that a portion of the support part 58 that is different from the knob parts 112a, 112b may be solder-bonded to the substrate 12. When a portion of the support part 58 that is different from the knob part 112a, 112b is solder-bonded to the substrate 12, the solder bonding may be performed before the support part 58 is clinch-fixed to the substrate 12.

### Modification 3 of Connection Terminal 15 (Connection Terminal 15d)

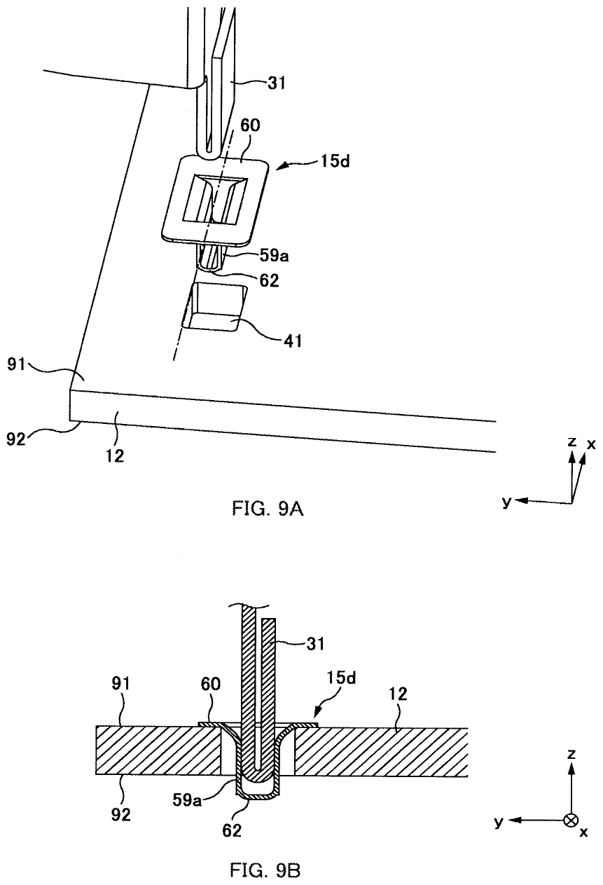

FIG. 9A is an example of an exploded perspective view and FIG. 9B is an example of a sectional side view, illustrating the substrate 12, a connection terminal 15d, and the feeding portion 31 of the antenna element 13. The connection terminal 15d has a holding part 59a and a support part 60.

As with the holding parts 51, 53, 55, and 57, the holding part 59 is coupled at a position closer to the back surface 92 than to the front surface 91 of the substrate 12.

Meanwhile, the support part 60 is a frame-shaped flat plate having a quadrilateral opening on the inner side in the radial direction. The support part 60 contacts the front surface 91 of the substrate 12 so as to surround the through-hole 41.

The support part 60 is fixed, at the surface thereof on the substrate 12 side, to the substrate 12 by solder bonding, for example. Accordingly, the support part 60 does not have such an insertable part as the insertable parts 74, of the support part 52, inserted into the holes 41a to 41d. Thus, no hole into which the insertable part is to be inserted is formed at the substrate 12. The holding part 59a is provided at the opposing sides of the quadrilateral opening of the support part 60 across the opening, and is inserted into the through-hole 41.

Note that the connection terminal 15d can also be manufactured from a single flat plate material. For example, a flat plate material in a state obtained by cutting the support part 60 along a dashed-dotted line illustrated in FIG. 9A and stretching the holding part 59a is prepared. Then, the stretched holding part 59a is bent and the support part 60 in the state obtained by cutting is butted and joined together, to thereby being able to manufacture the connection terminal 15d.

### Modification 4 of Connection Terminal 15 (Connection Terminal 15e)

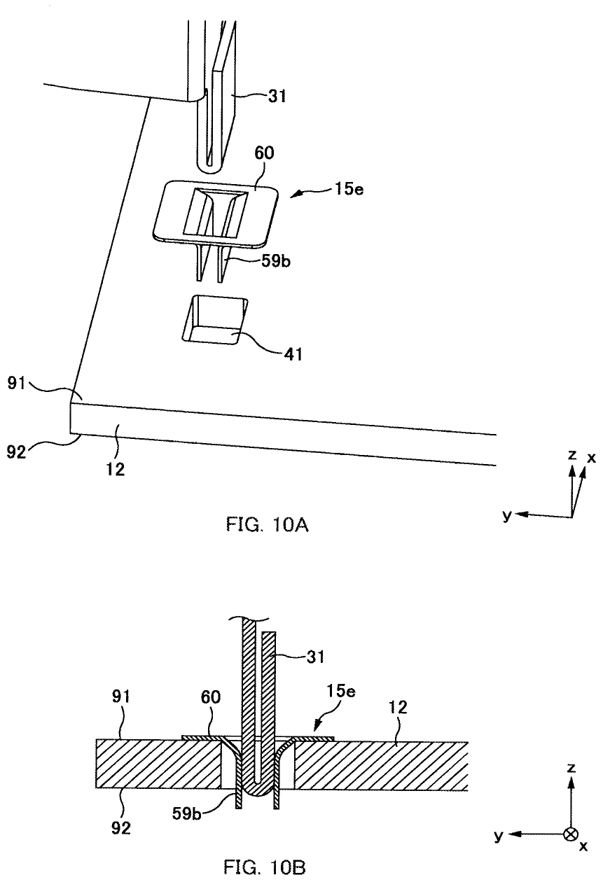

FIG. 10A is an example of an exploded perspective view and FIG. 10B is an example of a sectional side view, illustrating the substrate 12, a connection terminal 15e, and the feeding portion 31 of the antenna element 13.

The connection terminal 15e has a holding part 59b and the support part 60. The connection terminal 15e includes the support part 60 having the same structure as that of the connection terminal 15d. On the other hand, the holding part 59b has a structure different from that of the holding part 57. Accordingly, the following mainly describes the holding part 59b.

The holding part 59b has a split structure on the back surface 92 side of the substrate 12 relative to the front surface 91, and has no coupling part 62. Accordingly, the holding part 59b uses clamping parts having split ends to clamp the feeding portion 31 on the back surface 92 side of the substrate 12 relative to the front surface 91.

As described above, in the connection terminals 15b to 15e according to the modifications as well, the feeding portion 31 is held, by the holding parts thereof, on the back surface 92 side of the substrate 12 relative to the front surface 91. Accordingly, the connection terminals 15b to 15e can also reduce the height of the antenna device 100 and stabilize the posture of the antenna element 13 with respect to the substrate 12.

### Electrical Characteristics of Connection Terminal 15a

### About First Length

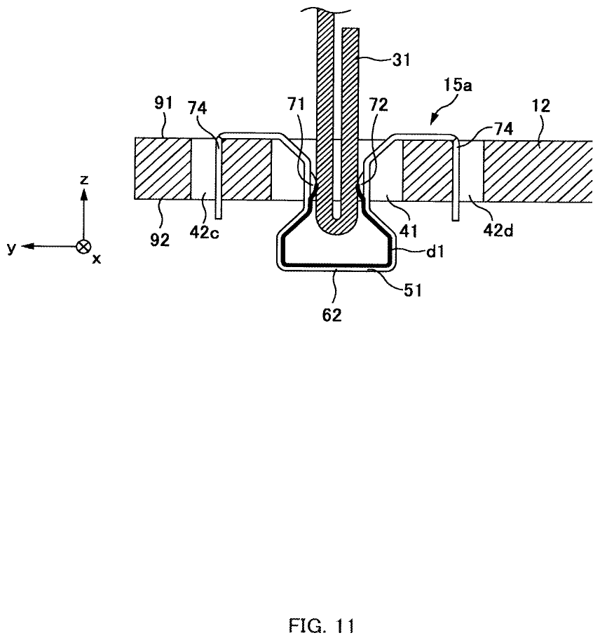

FIG. 11 is an example of a sectional side view of the connection terminal 15a, illustrating a first length d1 from the contact part 71 to the contact part 72 through at least a part of the holding part 51 and at least a part of the support part 52.

The first length is the shortest distance from the contact part 71 to the contact part 72 through a portion of the clamping part 61 below the contact part 71 and the coupling part 62. Note that the contact parts 71 and 72 correspond to not points but extended regions. The first length d1 is thus determined as follows.

Such two points at the lower boundary of the region of the contact part 71 that contacts the feeding portion 31 and at the lower boundary of the region of the contact part 72 that contacts the feeding portion 31, are selected so as to obtain the shortest distance through the surface of the connection terminal 15a on the feeding portion 31 side. The first length d1 is the shortest distance connecting these two points through the surface of the connection terminal 15a on the feeding portion 31 side.

The first length d1 affects a voltage standing wave ratio (VSWR) of the antenna device 100, as described below.

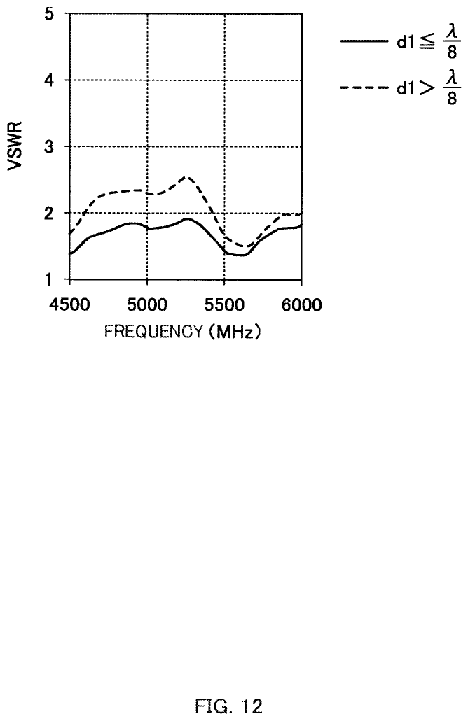

In FIG. 12, the horizontal axis represents frequency (MHz) and the vertical axis represents changes in VSWR of the antenna device 100 as the first length d1 changes. The same applies to the drawings illustrating other VSWRs below.

The lower the VSWR value, the better the impedance matching of the antenna device 100. Especially when the VSWR is less than or equal to 2, the antenna device 100 exhibits sufficiently good antenna characteristics.

In the frequency band supported by the antenna element 13 of an embodiment of the present disclosure, a wavelength λ is about 50 mm and λ/8=6.2 mm at the frequency of 6 GHz, for example. In FIG. 12, the solid line represents an example when the first length d1 is 5.2 mm (that is, d1<λ/8), and the dashed line represents an example when the first length d1 is 7.2 mm (that is, d1>λ/8).

In FIG. 12, when the first length d1 satisfies d1≤λ/8, the VSWR value is less than or equal to 2 in the frequency band of 4500 MHZ to 6 GHZ. Accordingly, when the first length d1 is set to d1≤λ/8, the antenna characteristics of the antenna device 100 at 4500 MHz to 6 GHz can be improved.

The shorter the first length d1, the smaller the connection terminal 15a becomes, and the rigidity may increase accordingly. When the rigidity of the holding part 51 becomes too high in the range of d1≤λ/8, the cutout portion 63 can be formed from the clamping part 61 to the coupling part 62, as in the connection terminal 15a, to thereby reduce the rigidity.

### About Second and Third Lengths

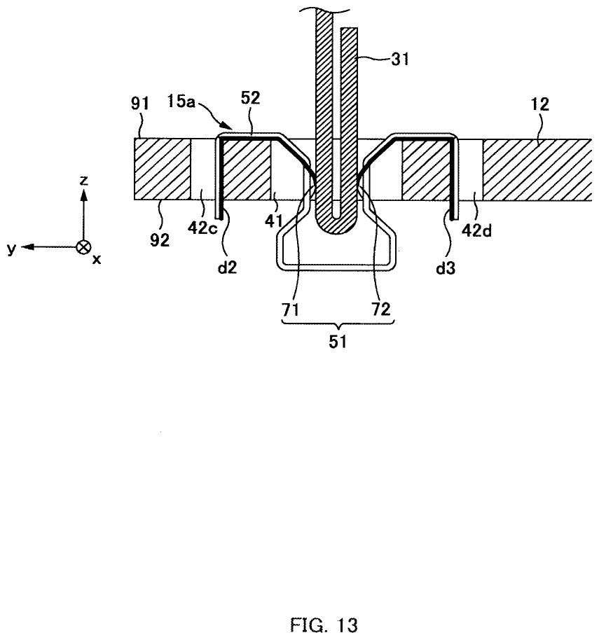

FIG. 13 is an example of a sectional side view of a connection terminal 15a, illustrating a second length d2 and a third length d3 from the contact part 71 to the open end of the support part 52 through at least a part of the holding part 51 and the support part 52.

In the connection terminal 15a, the second length d2 is a distance from the contact part 71 to the open end of the insertable part 74 protruding from the back surface of the substrate 12. Similarly, the third length d3 is a distance from the contact part 71 to the open end of the insertable part 74 protruding from the back surface of the substrate 12.

In the connection terminal 15a, the “open end” refers to the end of each of the insertable parts 74 inserted into the holes 42c and 42d, which protrudes downward from the back surface 92 of the substrate 12, and is a part that protrudes downward most. In an embodiment of the present disclosure, the open end of the connection terminal 15a is formed so as to protrude from the back surface of the substrate 12. The open end is, however, not limited thereto and may be formed so as to be positioned in the through-hole 41 in the substrate 12, for example.

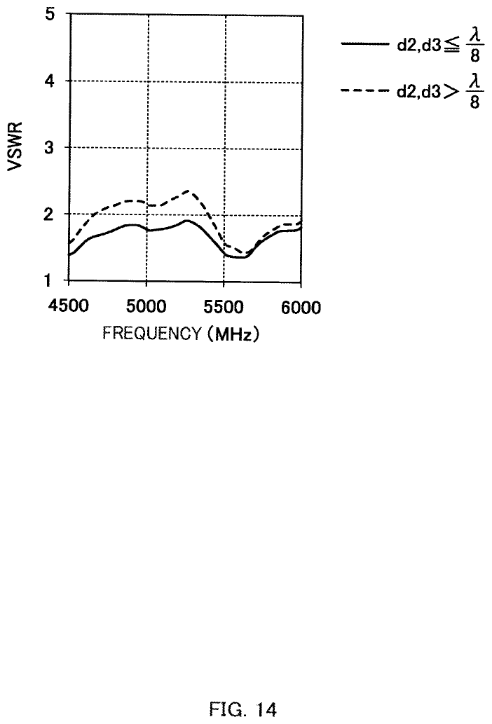

FIG. 14 illustrates an example of the VSWR of the antenna device 100 as the second length d2 and the third length d3 change.

In FIG. 14, the solid line represents an example when the second length d2 is 5.0 mm (that is, d2<λ/8) and the dashed line represents an example when the second length d2 is 7.0 mm (that is, d2>λ/8). Note that the same applies to VSWR diagram when the third length d3 is set to the same length as above.

In FIG. 14, when the second length d2 satisfies d2≤λ/8, the VSWR value is less than or equal to 2 in the frequency band of 4500 MHz to 6 GHZ. Accordingly, by setting the second length d2 (and the third length d3) to d2≤λ/8 (and d3≤λ/8), the antenna characteristics of the antenna element 13 at 4500 MHz to 6 GHz can be improved.

### About Fourth and Fifth Lengths

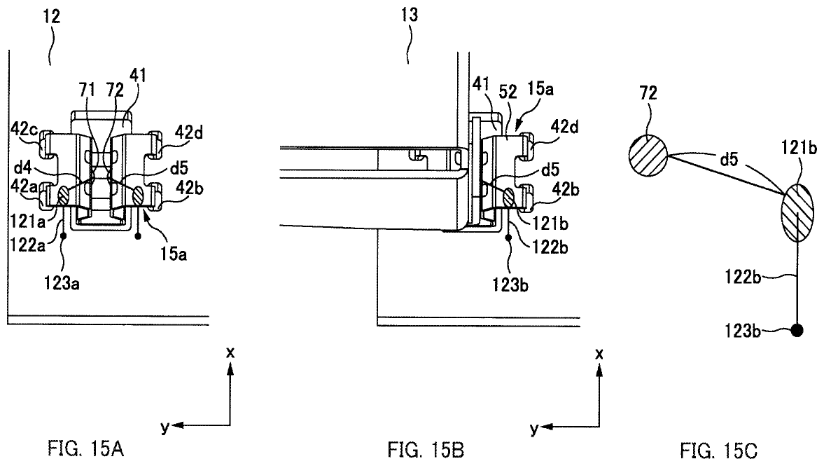

FIG. 15A is a perspective view of the connection terminal 15a attached to the substrate 12. FIG. 15B is a perspective view of the connection terminal 15a holding the antenna element 13. FIG. 15C is a conceptual diagram of a fifth length d5. FIG. 15A illustrates the connection terminal 15a engaged with the through-hole 41 and holes 42a to 42d in the substrate 12. FIG. 15B illustrates a state in which the feeding portion 31 of the antenna element 13 is held by the connection terminal 15a.

The connection parts 121a and 121b of the support part 52 are connected to the ports 123a and 123b through the patternings 122a and 122b at the front surface 91 of the substrate 12, respectively.

A fourth length d4 is the shortest distance connecting the connection part 121a and the contact part 71 through at least a part of the holding part 51 and at least a part of the support part 52. Similarly, the fifth length d5 is the shortest distance connecting the connection part 121b and the contact part 71 through at least a part of the holding part 51 and at least a part of the support part 52.

FIG. 15C is a conceptual diagram of the fifth length d5. To determine the fifth length d5, first, such a point at the boundary of the contact part 71 on the connection part 121b side, as to be close to the connection part 121b and enable the fifth length d5 to be shortest, is selected. Next, such a point at the boundary of the connection part 121b on the contact part 71 side, as to be close to the contact part 71 side and enable the fifth length d5 to be shortest, is selected. The distance connecting these two points by a straight line in plan view of the substrate 12, which is the shortest distance within the structure including at least a part of the holding part 51 and at least a part of the support part 52, is defined as the fifth length d5. The fourth length d4 is similarly determined.

When the width of the support part 52 in the x direction and the x coordinate of the connection part 121b (or the connection part 121a) are adjusted to set the fifth length d5 (or the fourth length d4) to less than or equal to λ/8, the third length d3 (or the second length d2) to the open end also changes significantly when the insertable part 74 to be inserted into the hole 41b (or the hole 41a) is provided.

Incidentally, for example, the shape of the connection terminal 15a may be changed so as to widen the region of the joint portion between the connection terminal 15a and the connection part 121a. In such a case, if the insertable part 74 is provided on the hole 41a side as well, the distance from the contact part 71 to the open end of the insertable part 74 increases. As a result, the second length d2 determined from the contact part 71 to the open end of the insertable part 74 may exceed λ/8.

Even when the shape of the connection terminal 15a is changed so as to widen the region of the joint portion, the second length d2 can be prevented from exceeding λ/8 by omitting the insertable part 74 on the hole 41a side. Here, the description has been given of the case where the shape of the connection terminal 15a is changed so as to widen the region of the joint portion between the connection terminal 15a and the connection part 121a. The same applies to the case of widening the region of the joint portion between the connection terminal 15a and the connection part 121b. This facilitates designing of the connection terminal 15a that satisfies the conditions for the second length d2 to the fifth length d5.

Note that the first length d1 to the fifth length d5 are similarly determined in the connection terminal 15b.

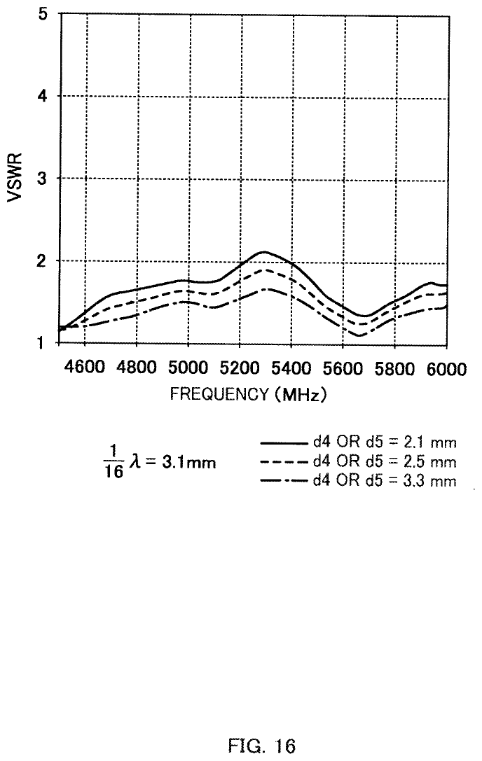

FIG. 16 illustrates an example of the VSWR of the antenna device 100 as the fifth length d5 changes.

In the frequency band supported by the antenna element 13 of an embodiment of the present disclosure, λ/16=3.1 mm at the frequency of 6 GHZ, for example. In FIG. 16, the solid line gives an example when the fifth length d5 is 3.3 mm (that is, d5>λ/16). The dashed line gives an example when the fifth length d5 is 2.5 mm (that is, d5<λ/16). The dashed-dotted line gives an example when the fifth length d5 is 2.1 mm (that is, d5<λ/16). Note that the same applies to VSWR diagrams when the fourth length is similarly set.

When the fifth length d5 satisfies d5≤λ/16 (and d4≤λ/16), the VSWR value is less than or equal to 2 in the frequency band of 4500 MHz to 6 GHz. Accordingly, by setting the fifth length d5 as d5≤λ/16 (and d4≤λ/16), the antenna characteristics of the antenna element 13 in the frequency band of 4500 MHz to 6 GHz can be improved.

Note that the connection parts 121a and 121b are connected to the patternings 122a and 122b and the ports 123a and 123b at the substrate 12, and the influence of the fourth length d4 and the fifth length d5 on the VSWR of the antenna device 100 is larger than the influence of the first length d1 to the third length d3 thereon. As a result, the influence on the VSWR can be sufficiently reduced by setting the first length d1 to the third length d3 to less than or equal to λ/8. Meanwhile, the influence on the VSWR can be sufficiently reduced by setting the fourth length d4 and the fifth length d5 to less than or equal to λ/16.

### First Length d1 to Fifth Length d5 in Connection Terminal 101

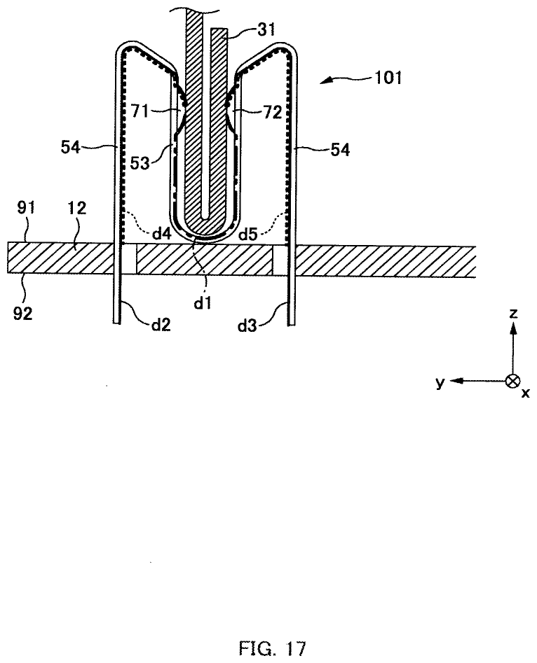

FIG. 17 illustrates an example of a sectional side view of the substrate 12, the connection terminal 101, and the feeding portion 31 of the antenna element 13. In the connection terminal 101 as well, the first length d1 to the fifth length d5 can be defined as illustrated in FIG. 17.

To determine the first length d1, two points at the lower boundary of the contact part 71 in contact with the feeding portion 31 and the lower boundary of the contact part 72 in contact with the feeding portion 31 are selected, so as to obtain the shortest distance through the surface of the connection terminal 15c on the feeding portion 31 side. The shortest distance connecting these two points through the surface of the connection terminal 15a on the feeding portion 31 side in the holding part 53 is the first length d1.

To determine the second length d2, a point at the boundary is determined so as to obtain the shortest distance, through a part of the holding part 53 and the support part 54, between the boundary on the upper side of the contact part 71 in contact with the feeding portion 31 and a point at the end (that is, the open end) of the support part 54 farthest from the through-hole 41. The shortest distance connecting these two points through a part of the holding part 53 and the support part 54 is the second length d2. The third length d3 is similarly determined from the contact part 72.

To determine the fourth length d4, two points at the upper boundary of the contact part 71 in contact with the feeding portion 31 and the boundary of the connection part 83a on the contact part 71 side are selected so as to obtain the shortest distance through a part of the holding part 53 and a part of the support part 54. The shortest distance connecting these two points through a part of the holding part 53 and a part of the support part 54 is the fourth length d4. The fifth length d5 is similarly determined from the contact part 72.

### Comparison Between Connection Terminal 15a and Connection Terminal 101

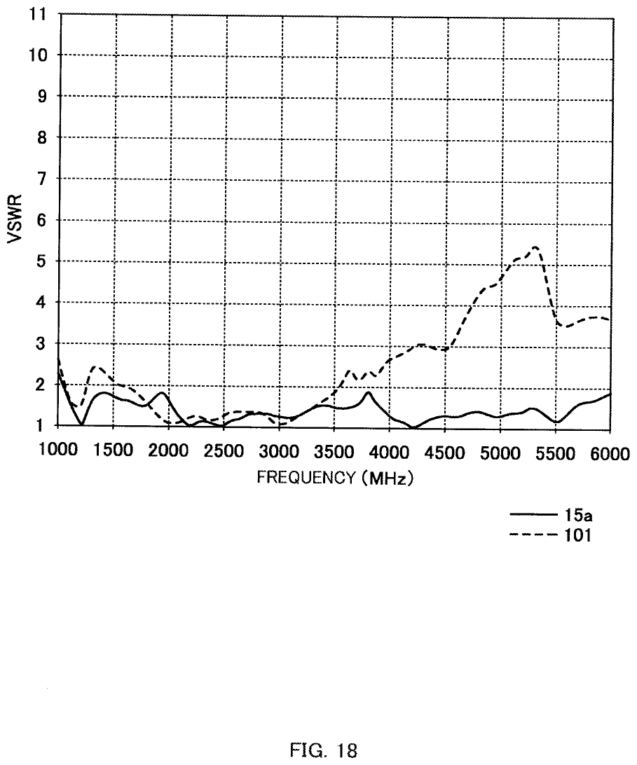

FIG. 18 illustrates an example of the VSWRs of the connection terminal 15a and the connection terminal 101. FIG. 18 illustrates the VSWR of the connection terminal 15a in which the first length d1 to the third length d3 are less than or equal to λ/8 and the fourth length d4 and the fifth length d5 are less than or equal to λ/16, and the VSWR of the connection terminal 101 in which the first length d1 to the third length d3 are set longer than λ/8 and the fourth length d4 and the fifth length d5 are set longer than λ/16.

The VSWR of the connection terminal 15a is lower than that of the connection terminal 101 as a whole. In FIG. 18, the influence on VSWR is noticeable particularly in the frequency band of 3500 MHZ to 6 GHZ. The VSWR greatly exceeds 2 in the connection terminal 101, and the VSWR is maintained less than or equal to 2 in the connection terminal 15a.

As described above, in the connection terminal 15a, by setting the first length d1 to the third length d3 to less than or equal to λ/8 and setting the fourth length d4 and the fifth length d5 to less than or equal to λ/16, the VSWR can be reduced and the antenna performance of the antenna device 100 can be improved. Likewise, in the connection terminal 101, by setting the first length d1 to the third length d3 to less than or equal to λ/8 and setting the fourth length d4 and the fifth length d5 to less than or equal to λ/16, the VSWR can be reduced and the antenna performance of the antenna device 100 can be improved.

### First Length d1 to Fifth Length d5 in Connection Terminal 15c

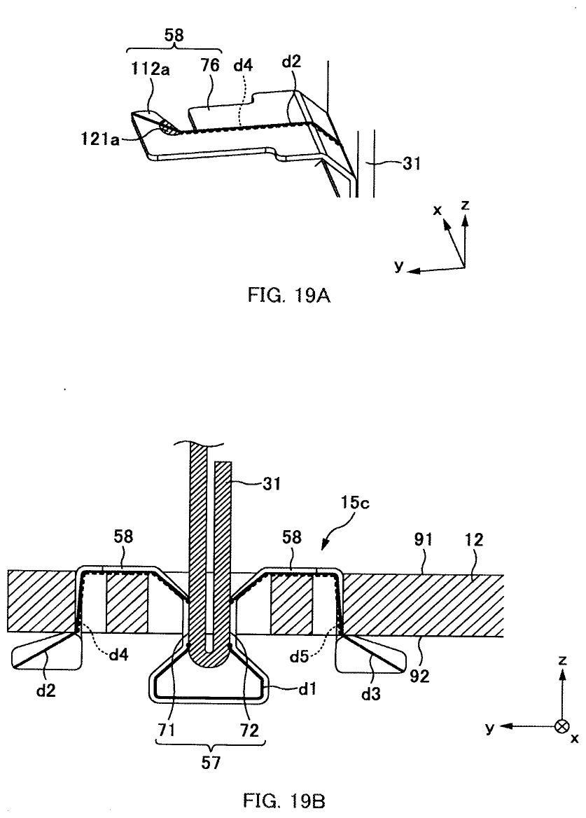

FIG. 19A is an example of a perspective view of the connection terminal 15c when unfolded. FIG. 19B is an example of a sectional side view of the connection terminal 15c. FIG. 19A is a perspective view for explaining the second length d2 and the fourth length d4, illustrating a case where the insertable part 76 is extended into a plane parallel to the x-y plane without being bent with respect to the support part 58.

The connection terminal 15c includes the connection part 121a in the knob part 112a, and includes the connection part 121b in the knob part 112b. The connection parts 121a and 121b are locations where the knob parts 112a and 112b are connected to the back surface 92 of the substrate 12 by solder bonding.

The connection terminal 15c includes no protruding contact parts. The connection terminal 15c includes, in the holding part 57, planar contact parts 71 and 72 which are portions to be surface contact with the feeding portion 31. In the connection terminal 15c as well, the first length d1 to the fifth length d5 are determined as follows.

To determine the first length d1, two points at the lower boundary of the contact part 71 in contact with the feeding portion 31 and the lower boundary of the contact part 72 in contact with the feeding portion 31 are selected so as to obtain the shortest distance through the surface of the connection terminal 15c on the feeding portion 31 side. The shortest distance connecting these two points through the surface of the connection terminal 15a on the feeding portion 31 side in the holding part 57 is the first length d1.

To determine the second length d2, a point at the boundary is determined so as to obtain the shortest distance, through a part of the holding part 57 and the support part 58, between the boundary on the upper side of the contact part 71 in contact with the feeding portion 31 and a point at the open end of the support part 58 farthest from the through-hole 41. The shortest distance connecting these two points through a part of the holding part 57 and the support part 58 is the second length d2. The third length d3 is similarly determined from the contact part 72.

To determine the fourth length d4, two points at the upper boundary of the contact part 71 in contact with the feeding portion 31 and the boundary of the connection part 121a on the contact part 71 side are selected so as to obtain the shortest distance through a part of the holding part 57 and a part of the support part 58. The shortest distance connecting these two points through a part of the holding part 57 and a part of the support part 58 is the fourth length d4. The fifth length d5 is similarly determined from the contact part 72.

### First Length d1 to Fifth Length d5 in Connection Terminal 15d

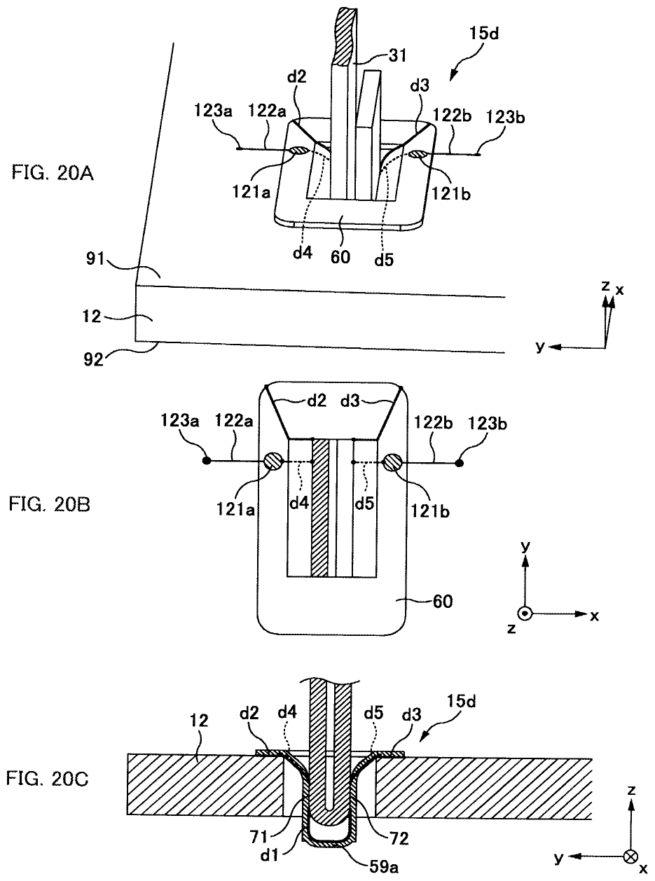

FIG. 20A is an example of a perspective view, FIG. 20B is an example of a top view, and FIG. 20C is an example of a sectional side view, illustrating the connection terminal 15d.

As with the connection terminal 15c, the connection terminal 15d has no protruding contact parts. As with the connection terminal 15c, the connection terminal 15c has planar contact parts 71 and 72, which are portions to be surface contact with the feeding portion 31, in the holding part 59a. In the connection terminal 15c as well, the first length d1 to the fifth length d5 are determined as follows.

The connection terminal 15d includes connection parts 121a and 121b between the surface of the support part 52 on the substrate 12 side and the front surface of the substrate 12.

The first length d1 in the connection terminal 15d can be set, as with the first length d1 in the connection terminal 15c. Two points at the lower boundary of the contact part 71 in contact with the feeding portion 31 and the lower boundary of the contact part 72 in contact with the feeding portion 31, are selected, so as to obtain the shortest distance through the surface of the connection terminal 15c on the feeding portion 31 side. The shortest distance connecting these two points through the surface of the connection terminal 15c on the feeding portion 31 side in the holding part 59a is the first length d1.

To determine the second length d2, a point at the boundary is determined so as to obtain the shortest distance, through a part of the holding part 59a and the support part 60, between the boundary on the upper side of the contact part 71 in contact with the feeding portion 31 and a point at the end (that is, the open end) of the support part 60 farthest from the through-hole 41. The shortest distance connecting these two points through a part of the holding part 59a and the support part 60 is the second length d2. The third length d3 is similarly determined from the contact part 72.

To determine the fourth length d4, two points at the upper boundary of the contact part 71 in contact with the feeding portion 31 and the boundary of the connection part 121a on the contact part 71 side are selected, so as to obtain the shortest distance through a part of the holding part 59a and a part of the support part 60. The shortest distance connecting these two points through a part of the holding part 59a and a part of the support part 60 is the fourth length d4. The fifth length d5 is similarly determined from the contact part 72.

### First Length d1 to Fifth Length d5 in Connection Terminal 15e

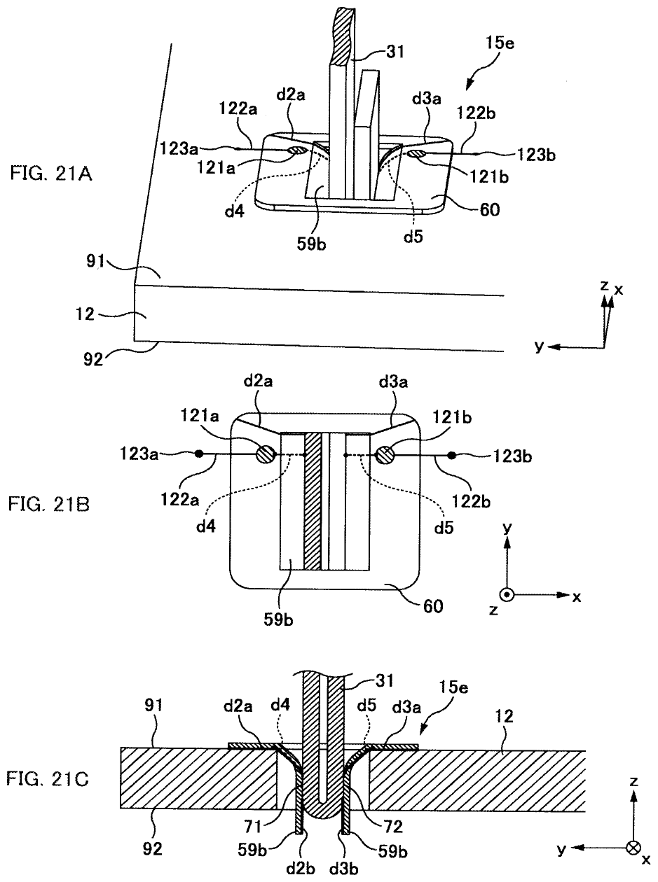

FIG. 21A is an example of a perspective view, FIG. 21B is an example of a top view, and FIG. 21C is an example of a sectional side view, illustrating the connection terminal 15e.

Unlike the connection terminal 15d, the connection terminal 15e has no coupling part 62 in the holding part 59b. Accordingly, the first length d1 is not determined in the connection terminal 15e. Instead, a second length d2b and a third length d3b are respectively determined from the contact parts 71 and 72 to the open ends protruding toward the back surface 92 of the substrate 12.

In the connection terminal 15e, second lengths d2a and d2b, which are the lengths from the contact part 71 to the open ends, and third lengths d3a and d3b, which are the lengths from the contact part 72 to the open ends, are determined as follows.

The second length d2a of the connection terminal 15e is determined as with the second length d2 of the connection terminal 15d. The third length d3a of the connection terminal 15e is determined similarly to the third length d3 of the connection terminal 15d.

Meanwhile, in the connection terminal 15e, the second length d2b from the contact part 71 to the open end protruding from the back surface of the substrate 12 can also be determined. The second length d2b is determined as the distance from the lower boundary of the contact part 71 in contact with the feeding portion 31 to the lower end of the holding part 59b. Similarly, the third length d3b is determined as the distance from the lower boundary of the contact part 72 in contact with the feeding portion 31 to the lower end of the holding part 59b.

When both the second lengths d2a and d2b are less than or equal to the wavelength λ/8 of electromagnetic waves supported by the connection terminal 15e and both the third lengths d3a and d3b are less than or equal to the wavelength λ/8 of electromagnetic waves supported by the connection terminal 15e, the VSWR of the antenna device 100 is less than or equal to 2.

The fourth length d4 and the fifth length d5 in the connection terminal 15e can be set as in the connection terminal 15d.

In the connection terminals 15c to 15e as well, the first length d1 to the third length d3 are designed to be less than or equal to λ/8 with respect to the wavelength λ supported by the antenna element 13, and the fourth length d4 and the fifth length d5 are designed to be less than or equal to λ/16, thereby being able to reduce VSWR. Accordingly, the antenna performance of the antenna device 100 can be improved even when the connection terminals 15c to 15e are used.

### Structure of Antenna Element 13

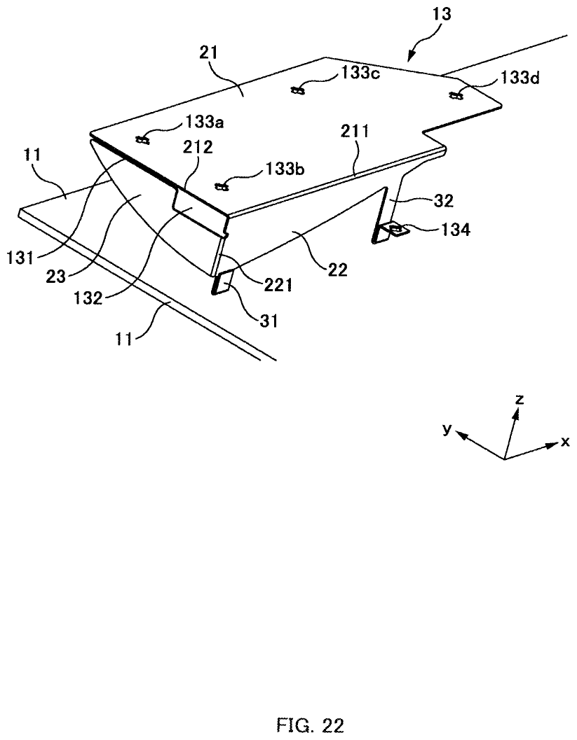

FIG. 22 illustrates an example of a perspective view of the antenna element 13. The antenna element 13 includes the top plate portion 21, the side plate portions 22 and 23, the feeding portion 31, and the short-circuit portion 32. The antenna element 13 further includes a gap 131 and a cutout portion 132 between the top plate portion 21 and the side plate portion 23. The top plate portion 21 is connected through a side 211, and the side plate portions 22 and 23 are connected through a side 221. The top plate portion 21 has a side 212 adjacent to the side 211.

The antenna element 13 of an embodiment of the present disclosure is provided by integrally molding from a single sheet metal. Accordingly, the top plate portion 21, the side plate portions 22 and 23, the feeding portion 31, and the short-circuit portion 32 are formed by bending and cutting a single sheet metal. This electrically connects the top plate portion 21 and the side plate portions 22 and 23 to each other. The antenna element 13 of an embodiment of the present disclosure is made of metal, but may be made of a conductive member and the material thereof is not limited to metal.

The top plate portion 21 is a flat element facing the ground portion 11. In an embodiment of the present disclosure, when the antenna element 13 is held at the substrate 12 by the connection terminal 15a, the top plate portion 21 is provided substantially parallel to the ground portion 11 (accordingly, substantially parallel to the x-y plane). The top plate portion 21 includes four holes 133a to 133d. However, the number of holes 133 included in the top plate portion 21 is not limited to four, and may be a different number depending on design requirements such as the shape of the antenna element 13 and fixing conditions of the case 14.

The holes 133a to 133d are holes for fixing the antenna element 13 to the case 14. The protruding portions formed at the case 14 are inserted into the holes 133a to 133d, and the protruding portions of the case 14 are heated, to be welded. The means for fixing the antenna element 13 to the case 14 is not limited thereto. As described above, various joining methods such as snap-fitting, screwing, adhesion, and/or the like may be adopted.

The side plate portion 22 is a flat element provided in a direction from the side 211 of the top plate portion 21 to the ground portion 11. Note that the side plate portion 22 of an embodiment of the present disclosure is provided in a direction perpendicular to the top plate portion 21 toward the ground portion 11 (in a direction substantially parallel to the z-x plane). The side plate portion 22 may be provided in a direction oblique to the top plate portion 21 toward the ground portion 11. The feeding portion 31 and the short-circuit portion 32 of an embodiment of the present disclosure are provided at the side plate portion 22.

The side plate portion 22 has a tapered shape with a curved side closer to the ground portion 11 and a width decreasing away from the side plate portion 23. Such a shape makes it possible to widen the frequency band supported by the antenna element 13. However, the shape of the side plate portion 22 is not limited thereto, and the side closer to the ground portion 11 may be substantially parallel to the ground portion 11 and the top plate portion 21.

The side plate portion 23 is a flat element provided in a direction from the side 212 adjacent to the side 211 of the top plate portion 21 toward the ground portion 11. The side plate portion 23 of an embodiment of the present disclosure forms a vertical angle with respect to the top plate portion 21, and also forms a vertical angle with respect to the side plate portion 22. As with the side plate portion 22, the side plate portion 23 may be provided in a direction oblique to the top plate portion 21 toward the ground portion 11. The side plate portion 23 is provided in a direction substantially parallel to the y-z plane.

The side plate portion 23 provided between the top plate portion 21 and the ground portion 11 also has a tapered shape with a width decreasing away from the side plate portion 22. Such a shape makes it possible to widen the frequency band supported by the antenna element 13. However, the shape of the side plate portion 23 is not limited thereto, and the side closer to the ground portion 11 may be substantially parallel to the ground portion 11 and the top plate portion 21.

Note that the side plate portion 23 may be omitted, depending on the state of the ground portion 11 and electrical conditions, such as when sufficient antenna performance is ensured in the characteristics of the middle and high range of electromagnetic waves supported by the antenna device 100. This can reduce the manufacturing cost of the antenna device 100.

The gap 131 is provided between the top plate portion 21 and the side plate portion 23. The provision of the gap 131 enables the antenna element 13 to be easily manufactured by bending a flat plate material. The flat plate material is bent at the side 211 connecting the top plate portion 21 and the side plate portion 22 and at the side 221 connecting the side plate portion 22 and the side plate portion 23, such that the upper side of the side plate portion 23 and the side 221 of the top plate portion 21 oppose each other across the gap 131. The antenna element 13 can thus be manufactured by bending a single flat plate material.

The cutout portion 132 is formed in the side plate portion 23 so as to be continuous with the gap 131 near the corner formed by the three plate-shaped elements, which are the top plate portion 21 and the side plate portions 22 and 23. The cutout portion 132 of an embodiment of the present disclosure has a substantially quadrilateral shape, but the shape of the cutout portion 132 is not limited to the substantially quadrilateral shape.

With the provision of the gap 131, the gap 131 functions as a capacitive element between the top plate portion 21 and the side plate portion 23, which causes unintended resonance between the top plate portion 21 and the side plate portion 23. Without the cutout portion 132, the gap 131 causes resonance having a resonance frequency of 1.5 GHZ, for example. If no countermeasures is taken against this, impedance matching of the antenna element 13 will become difficult, resulting in deterioration of the VSWR of the antenna device 100.

On the other hand, with the provision of the cutout portion 132, the resonance frequency of the resonance caused by the gap 131 and the cutout portion 132 is changed to 1.2 GHz, for example. When the antenna device 100 is a 5G telematics antenna, the supported frequencies are, for example, 600 MHz to 960 MHz and 1400 to 6000 MHz. Accordingly, in this case, resonance at a frequency of 1.2 GHz is outside the supported frequency range. As such, the cutout portion 132 shifts the unintended resonance frequency caused by the gap 131 to resonance outside the frequency range supported by the antenna device 100.

Particularly, with the provision of the gap 131 and the cutout portion 132 at a position close to the feeding portion 31, the gap 131 and the cutout portion 132 are less likely to affect the low frequency band of the antenna device 100. That is, it becomes easier to design the antenna device 100 that can easily support a wide band and has high performance. Note that, in the antenna element 13, an element provided at a position close to the feeding portion 31 supports a high frequency band, and an element provided at a position away from the feeding portion 31 supports a low frequency band.

Here, the side plate portions 22 and 23 can also be joined by welding, soldering, and/or by superposing and screwing the side plate portions 22 and 23, such that no gap 131 is formed. In this case, the cutout portion 132 can also be omitted. In an embodiment of the present disclosure, the gap 131 and the cutout portion 132 are provided to facilitate the manufacturing of the antenna element 13 from a flat plate material.

In the antenna element 13 of an embodiment of the present disclosure, a round bending hole (optional) is provided in a portion of the side plate portion 22 continuous with the lower end of the cutout portion 132, so that the side plate portion 23 can be easily bent with respect to the side plate portion 22.

In the connection terminal 15a, the feeding portion 31 and the short-circuit portion 32 are provided at the common side plate portion 22. Alternatively, one of the feeding portion 31 or the short-circuit portion 32 may be provided at the side plate portion 22, and the other may be provided at a different member of the antenna element 13, such as the side plate portion 23 or the like.

The longer the electrical length from the feeding portion 31 to the ground portion 11, through the inside of the antenna element 13 and the short-circuit portion 32, the lower the frequency supported by the antenna element 13. The shorter the electrical length, the higher the frequency supported by the antenna element 13. Accordingly, using a plurality of plate-shaped members, instead of a linear member, to configure the antenna element 13 as in an embodiment of the present disclosure widens the possible range of the path from the feeding portion 31 to the ground portion 11. This also widens the range of the electrical length of the path, which enables the antenna element 13 to support a wide range of frequency bands.

The closer the position of the short-circuit portion 32 is to the position of the feeding portion 31, the lower the VSWR in the low frequency band is and the higher the VSWR in the high frequency band is. On the other hand, the farther the position of the short-circuit portion 32 is from the position of the feeding portion 31, the lower the VSWR in the low frequency band is and the higher the VSWR in the high frequency band is. Thus, the short-circuit portion 32 and the feeding portion 31 are provided at such a distance therebetween so as to be able to obtain a low VSWR in a desired frequency band.

Accordingly, the feeding portion 31 may be provided at either one of the side plate portions 22 or 23. However, with the short-circuit portion 32 being provided at a longer one, in plan view, out of the side plate portions 22 and 23, thereby being able to keep more distance from the feeding portion 31. This facilitates reduction in the VSWR in the low frequency band.

The short-circuit portion 32 of an embodiment of the present disclosure is folded at its tip portion to be inserted into the connection terminal, and the tip of the folded portion is further bent at a substantially right angle. This bent part has a hole 134 formed therein. As with the holes 133a to 133d, the hole 134 is a hole for the protruding portion formed at the case 14 to be inserted thereinto, and for the protruding portion of the case 14 to be heated, to be welded therein. Note that the hole 134 can be omitted depending on the fixing condition or the like of the case 14 in the antenna device 100.

The top plate portion 21 corresponds to a “first flat plate portion”, the side plate portion 22 corresponds to a “second flat plate portion”, and the side plate portion 23 corresponds to a “third flat plate portion”. The cutout portion 132 corresponds to a “second cutout portion”.

Arrangement of Antenna Element 13 on or above Substrate 12

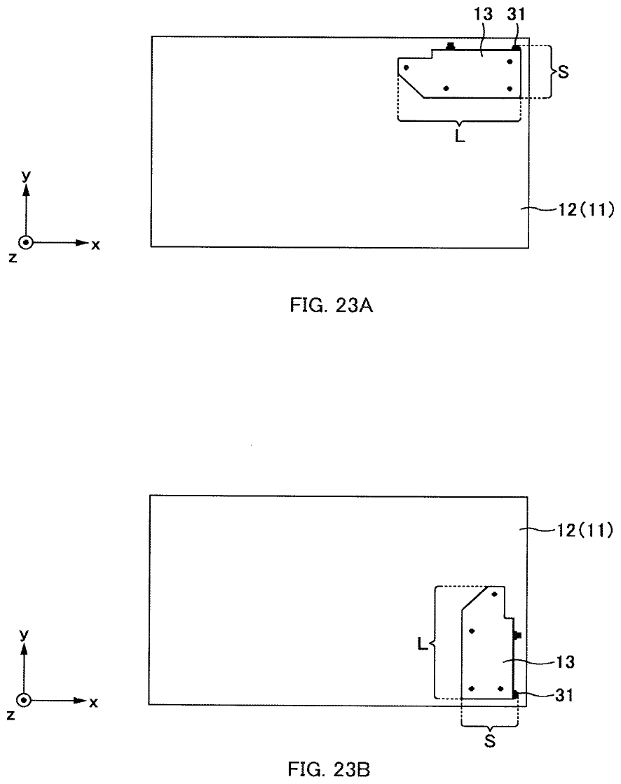

FIGS. 23A and 23B each illustrate an example of a top view of the substrate 12, where the feeding portion 31 of the antenna element 13 is disposed at a corner of the substrate 12. FIGS. 23A and 23B each illustrate an example where the ground portion 11 and the substrate 12 have the same shape. In FIGS. 23A and 23B, the antenna element 13 has a long side L and a short side S in plan view of the substrate 12.

In an arrangement example of FIG. 23A, the feeding portion 31 of the antenna element 13 is arranged at the upper right corner of the substrate 12 with the long side L of the antenna element 13 aligned with the long side of the ground portion 11 and the substrate 12. On the other hand, in an arrangement example of FIG. 23B, the feeding portion 31 of the antenna element 13 is arranged at the lower right corner of the substrate 12 with the long side L of the antenna element 13 aligned with the short side of the ground portion 11 and the substrate 12.

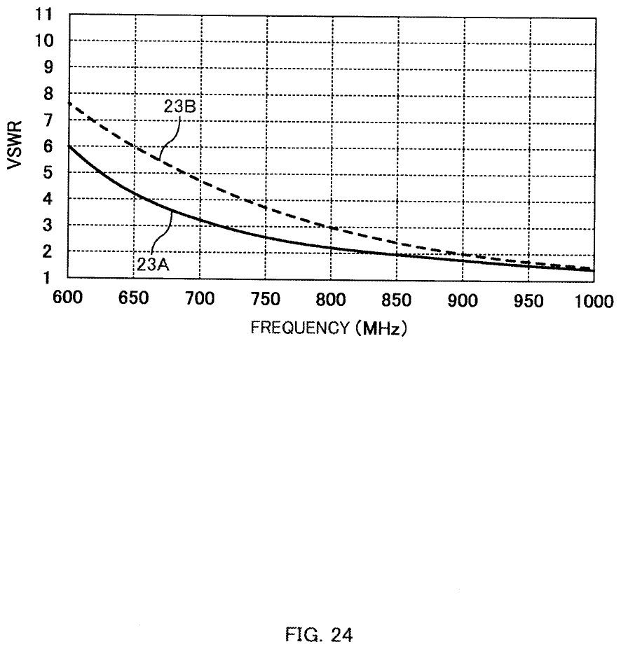

With reference to FIG. 24, VSWRs in the arrangement example of FIG. 23A and the arrangement example of FIG. 23B will be described. FIG. 24 illustrates an example of the VSWR of the antenna device 100 in each of the arrangement examples illustrated in FIGS. 23A and 23B.

As illustrated in FIG. 24, the VSWR of the arrangement example in FIG. 23A is lower than the VSWR of the arrangement example in FIG. 23B. Accordingly, when the antenna element 13 is disposed at a corner of the substrate 12, better antenna performance is achieved by aligning the long side L of the antenna element 13 with the long side of the ground portion 11 and the substrate 12, as in the arrangement example of FIG. 23A.

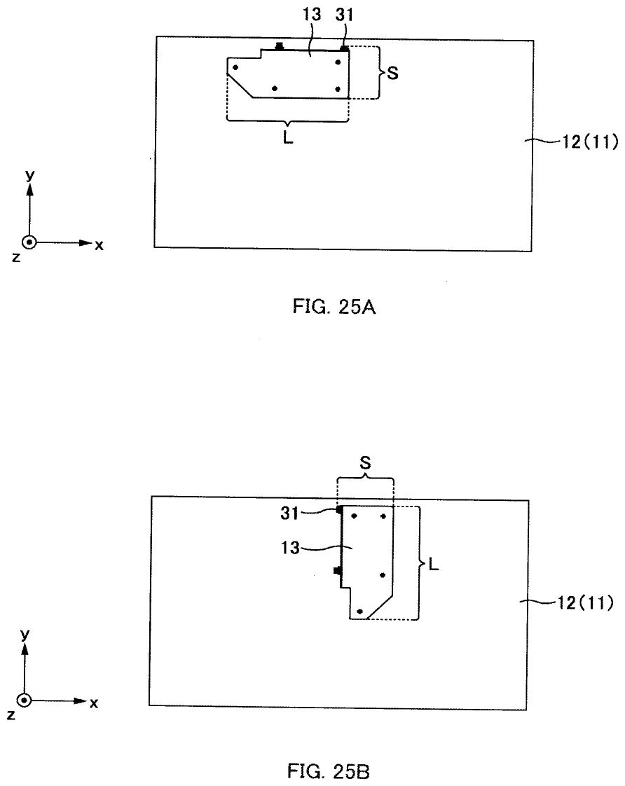

FIGS. 25A and 25B each illustrate an example of a top view of the substrate 12, where the feeding portion 31 of the antenna element 13 is arranged in the vicinity of the midpoint of the long side of the substrate 12. The term “vicinity” means within a circle with a predetermined radius (for example, 5 mm) about a certain point.

In an arrangement example of FIG. 25A, the feeding portion 31 of the antenna element 13 is arranged in the vicinity of the midpoint of the long side of the ground portion 11 and the substrate 12, with the long side L of the antenna element 13 aligned with the long side of the ground portion 11 and the substrate 12.

On the other hand, in an arrangement example of FIG. 25B, the feeding portion 31 of the antenna element 13 is arranged in the vicinity of the midpoint of the long side of the ground portion 11 and the substrate 12, with the short side S of the antenna element 13 aligned with the long side of the ground portion 11 and the substrate 12.

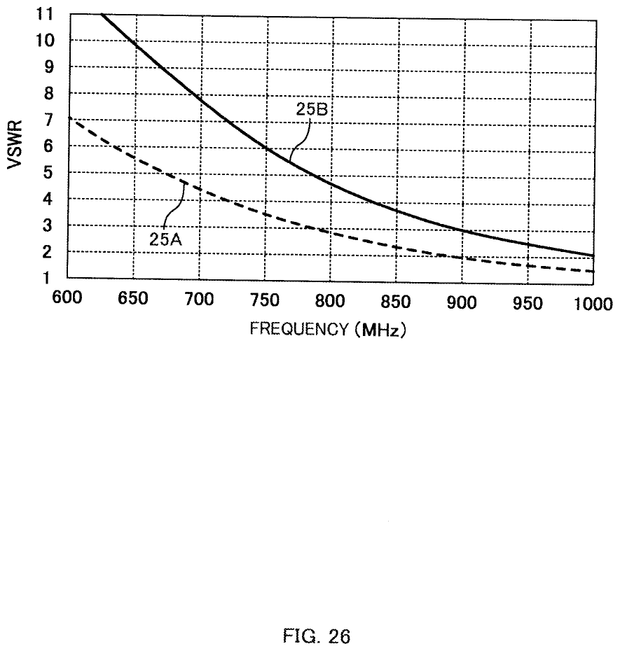

FIG. 26 illustrates an example of the VSWR of the antenna device 100 in each of the arrangement examples illustrated in FIGS. 25A and 25B. As illustrated in FIG. 26, the VSWR of the arrangement example of FIG. 25A is lower than the VSWR of the arrangement example of FIG. 25B.

When the feeding portion 31 is arranged with respect to the ground portion 11 and the substrate 12, a current flows from the substrate 12 to the feeding portion 31 and also flows toward the ground portion 11.

The current flowing along the long side L of the antenna element 13 has a long electrical length, and thus is related to the VSWR of the antenna device 100 in the low frequency band. When the long side L of the antenna element 13 and the long side of the ground portion 11 are aligned, a current along the direction of the long side L of the antenna element 13 can easily flow through the long side of the ground portion 11, thereby reducing the VSWR of the antenna device 100 in the low frequency band. Accordingly, in the arrangement example of FIG. 25A, the VSWR of the antenna device 100 in the low frequency band is improved.

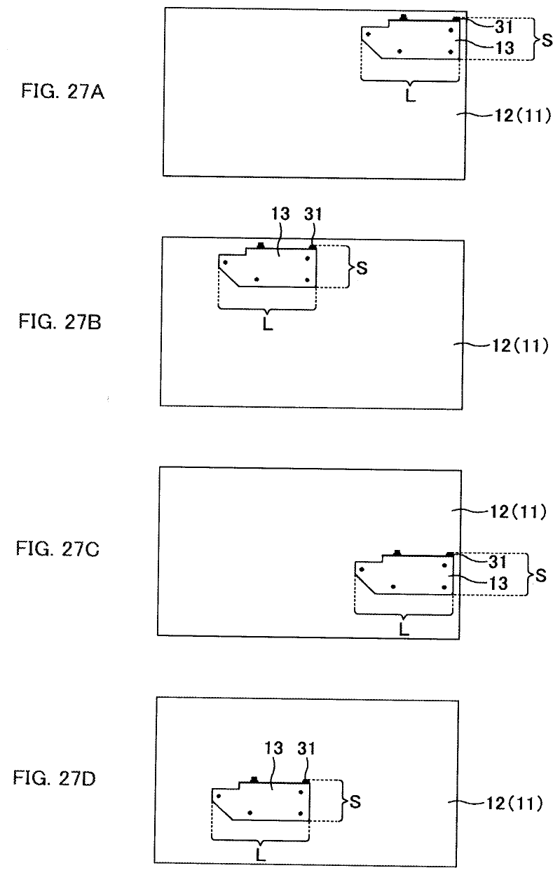

FIGS. 27A to 27D each illustrate an example of a top view of the substrate 12, where the antenna element 13 is arranged on or above the substrate 12. In FIGS. 27A to 27D, the antenna element 13 is arranged such that the long side L of the antenna element 13 is aligned with the long side of the substrate 12. In this case, the following four arrangement examples will be described.

In the arrangement example of FIG. 27A, the feeding portion 31 of the antenna element 13 is arranged at a corner of the substrate 12. In the arrangement example of FIG. 27B, the feeding portion 31 is arranged in the vicinity of the midpoint of the long side of the substrate 12. In the arrangement example of FIG. 27C, the feeding portion 31 is arranged in the vicinity of the midpoint of the short side of the substrate 12. In the arrangement example of FIG. 27D, the feeding portion 31 is arranged in the vicinity of the center (geometric center) of the substrate 12.

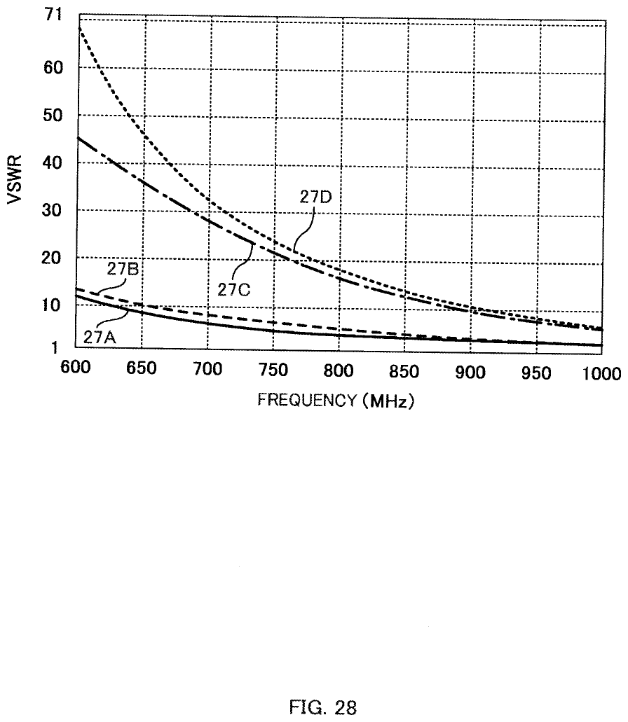

FIG. 28 illustrates an example of the VSWR of the antenna device 100 in each of the arrangement examples illustrated in FIGS. 27A to 27D.

As illustrated in FIG. 28, the magnitude of VSWR is as follows: the arrangement example of FIG. 27A <the arrangement example of FIG. 27B<the arrangement example of FIG. 27C< the arrangement example of FIG. 27D. The reason for this will be described below.

When the feeding portion 31 is arranged with respect to the ground portion 11 and the substrate 12, a current flows from the substrate 12 to the feeding portion 31 as well as currents radial with the feeding portion 31 as the center, in plan view of the ground portion 11 and the substrate 12, also flows toward the ground portion 11.

In contrast to the current flowing in one direction from the feeding portion 31, currents flowing in directions point-symmetrical with respect to the feeding portion 31 cancel each other. The more the currents canceling each other are, the less likely the currents flow to the ground. This causes deterioration of the VSWR in the supported frequency band, especially in the low frequency band.

When the feeding portion 31 is arranged closer to the center of the substrate 12, the currents radial with the feeding portion 31 as the center, in plan view of the ground portion 11 and the substrate 12, are more likely to flow in the directions point-symmetrical with respect to the feeding portion 31. Accordingly, in the antenna device 100, when the feeding portion 31 is arranged closer to the outer edge of the substrate and, in addition, closer to a corner of the outer edge, the VSWR is lowered and the antenna characteristics are improved.

Accordingly, the VSWR of the arrangement example of FIG. 27A is significantly lower than that of the arrangement example of FIG. 27D, and is also lower than those of the arrangement examples of FIGS. 27B and 27C since the cancellation of the currents can be reduced by an amount corresponding to those along the sides of the substrate.

Furthermore, the arrangement example of FIG. 27B and the arrangement example of FIG. 27C are compared. In the arrangement example of FIG. 27B, the antenna element 13 is arranged in the vicinity of the midpoint of the long side of the substrate 12 in the outer edge of the substrate 12, with the long side L of the antenna element 13 aligned with the long side of the substrate 12. As such, in the arrangement example of FIG. 27B, the long side L of the antenna element 13 is aligned with the outer edge of the substrate 12.

Meanwhile, in the arrangement example of FIG. 27C, the antenna element 13 is arranged in the vicinity of the midpoint of the short side of the substrate 12 in the outer edge of the substrate 12, with the short side S of the antenna element 13 aligned with the short side of the substrate 12.

As for the arrangement examples of FIGS. 25A and 25B, as already have been described with reference to FIG. 26, the VSWR is lower when the long side L of the antenna element 13 is aligned with the outer edge of the ground portion 11 and the substrate 12. Accordingly, the VSWR is significantly lower in the arrangement example of FIG. 27B than in the arrangement example of FIG. 27C.

The antenna characteristics of the antenna device 100 are improved when the antenna element 13 is arranged, on or above the substrate 12 illustrated in FIGS. 23A to 28, as follows. Accordingly, when arranging the antenna element 13 on or above the substrate 12, the feeding portion 31 is to be arranged at a corner of the substrate 12 as much as possible. When the feeding portion 31 cannot be arranged at a corner due to design, the feeding portion 31 is arranged at the outer edge portion of the substrate 12. In addition, the long side L of the antenna element 13 is aligned with the outer edge of the substrate 12, particularly with the long side of the substrate 12.

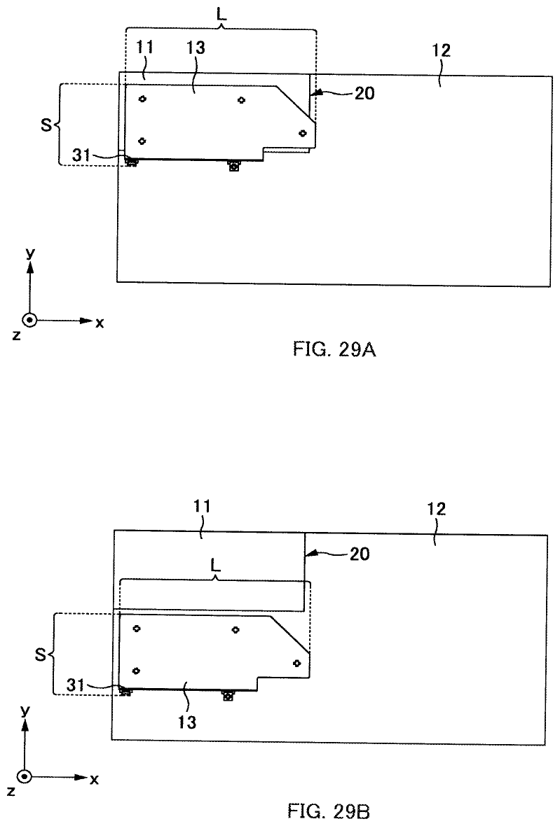

FIGS. 29A and 29B each illustrate an example of a top view of the substrate 12, where the antenna element 13 is arranged on or above the substrate 12.

The substrate 12 is provided on or above the ground portion 11 and overlaps with the ground portion 11 in plan view. The size of the substrate 12 is smaller than or equal to the size of the ground portion 11 in plan view. The cost of the antenna device 100 can be reduced by minimizing the size of the substrate 12 relative to the size of the ground portion 11.

Accordingly, in an embodiment of the present disclosure, the substrate 12 has a substantially quadrilateral cutout portion 20 at the upper left corner in FIGS. 29A and 29B. In the arrangement example of FIG. 29A and the arrangement example of FIG. 29B, the feeding portion 31 of the antenna element 13 is arranged at a position close to the upper left corner of the substrate 12.

In the arrangement example of FIG. 29A, the feeding portion 31 is arranged at the upper left corner of the substrate 12, with the long side L of the antenna element 13 aligned with the long side of the substrate 12. Further, a part of the antenna element 13 is arranged, on or above the ground portion 11, in a region overlapping with the cutout portion 20 in plan view, that is, at a position outside the substrate 12. Note that “outside” of the substrate 12 refers to a region that does not overlap with the substrate 12 in plan view.

Meanwhile, in the arrangement example of FIG. 29B, the feeding portion 31 is shifted to the negative side in the y direction such that the antenna element 13 is arranged on or above the ground portion 11 and the substrate 12 (the entire antenna element 13 lies above the substrate 12 in plan view). The VSWRs of these examples are compared.

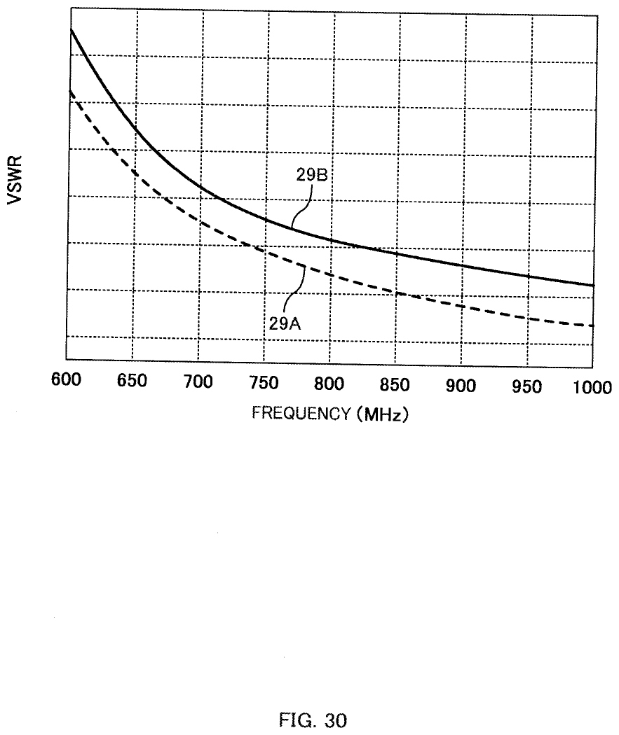

FIG. 30 illustrates an example of the VSWR of the antenna device 100 in each of the arrangement examples illustrated in FIGS. 29A and 29B. As illustrated in FIG. 30, the VSWR of the arrangement example of FIG. 29A is lower than the VSWR of arrangement example of FIG. 29B.

Accordingly, it can be seen that when the substrate 12 is provided such that the size of the substrate 12 is minimized in plan view relative to the ground portion 11, the arrangement example of FIG. 29A achieves better antenna performance than the arrangement example of FIG. 29B. In the arrangement example of FIG. 29A, as compared to the arrangement example of FIG. 29B, the apparent height from the top plate portion 21 of the antenna element 13 to the ground portion 11 or the substrate 12 provided below the antenna element 13 is increased while maintaining the overall height of the antenna device 100. This is one of the reasons for the difference in antenna performance between the arrangement example of FIG. 29A and the arrangement example of FIG. 29B.

As such, with the feeding portion 31 of the antenna element 13 being attached at the outer edge portion of the substrate 12 such that a part of the antenna element 13 is located outside the substrate 12, it is possible to improve the antenna performance of the antenna device 100, while reducing the size of the substrate 12.

### Summary

The connection terminals 15a to 15e configured to connect the antenna element 13 to the substrate 12 are provided. Among these connection terminals, the connection terminal 15a has the holding part 51 configured to hold the antenna element 13 at a position closer to the back surface 92 than to the front surface 91 of the substrate 12.

This makes it possible to reduce the height of the antenna device 100.

The support part 52 configured to support the connection terminal 15a against the through-hole 41 in the substrate 12 includes the surface contact part 73 to be surface contact with the front surface 91 of the substrate 12.

This makes it possible to stabilize the posture of the antenna element 13 when the antenna element 13 is connected to the substrate 12 through the connection terminal 15a.

The holding part 51 includes the clamping parts 61a and 61b configured to clamp the feeding portion 31 of the antenna element 13, and the coupling part 62.

This makes it possible to secure the feeding portion 31 to the substrate 12 not by solder bonding or the like, but by elastic force of the connection terminal 15a.

Further, the holding part 51 of the connection terminal 15a includes two cutout portions 63.

This makes it possible to reduce the rigidity of the holding part 51, thereby allowing the feeding portion 31 to be smoothly inserted into the holding part 51.

The cutout portion 63 is formed from the clamping part 61a to the clamping part 61b through the coupling part 62.

This facilitates reduction in the rigidity acting in the direction of the clamping force of the clamping part 61a while maintaining the structure of the connection terminal 15a.

The connection terminals 15a to 15e or the connection terminal 101 is provided, in which at least one of the first length d1 to the third length d3 is less than or equal to λ/8, or at least one of the fourth length d4 and the fifth length d5 is λ/16.

This makes it possible to reduce the VSWR of the antenna device 100 that uses the VSWR of the connection terminals 15a to 15e or the connection terminal 101. Accordingly, the antenna characteristics of the antenna device 100 using these connection terminals can be improved.

Provided is the antenna device 100 including: the substrate 12 to which any one of the connection terminals 15a to 15e and the connection terminal 101 that satisfies the conditions of the first length d1 to the fifth length is attached; the antenna element 13 connected to the substrate 12 through the connection terminal; and the ground portion 11.

This makes it possible to achieve good antenna characteristics of the antenna device 100 while reducing the height of the antenna device 100.

The antenna element 13 includes the top plate portion 21 and the side plate portions 22 and 23. The feeding portion 31 is provided to at least one of the side plate portions 22 and 23. The top plate portion 21 and the side plate portions 22 and 23 are electrically connected to each other. The gap 131 is formed between the top plate portion 21 and the side plate portion 23. The side plate portion 23 includes the cutout portion 132 continuous with the gap 131.

The antenna element 13 as such can be easily manufactured from a single flat plate material. Even when the gap 131 causes unintended resonance, the frequency of resonance caused by the gap 131 and the cutout portion 132 can be shifted to a frequency not supported by the antenna device 100.

At least a part of the antenna element 13 is located outside the substrate 12 in plan view of the substrate 12. At least a part of the antenna element 13 located outside the substrate 12 overlaps with the ground portion 11.

This makes it possible to provide the antenna device 100 having good antenna characteristics, while reducing the size of the substrate 12 relative to the size of the ground portion 11 and thus reducing costs.

The clamping parts 61a and 61b configured to clamp the feeding portion 31 of the antenna element 13 are positioned inside the through-hole 41 in the substrate 12.

This makes it possible to reduce the height of the antenna device 100.

Embodiment(s) of the present disclosure described above is/are simply to facilitate understanding of the present disclosure and is/are not in any way to be construed as limiting the present disclosure. The present disclosure may variously be changed or altered without departing from its essential features and encompass equivalents thereof.

### REFERENCE SIGNS LIST

11 ground portion

12 substrate

13 antenna element

14 case

15 connection terminal

20 cutout portion

21 top plate portion

22 side plate portion

23 side plate portion

31 feeding portion

32 short-circuit portion

41 through-hole

42, 43, 44, 133, 134 hole

51, 53, 55, 57, 59 holding part

52, 54, 56, 58, 60 support part

61 clamping part

62 coupling part

63 cutout portion

71, 72 contact part

73 surface contact part

74, 76 insertable part

81 locking part

82 bent part

83 connection part

91 front surface

92 back surface

100 antenna device

101 connection terminal

111 twist part

112 knob part

121 connection part

122 patterning

123 port

131 gap

132 cutout portion

211, 212, 221 side

1. A connection terminal configured to connect an antenna element to a substrate, the connection terminal comprising:
a holding part configured to hold a holdable part of the antenna element inserted from one surface of the substrate into a through-hole formed in the substrate, at a position on a side of another surface of the substrate opposite to the one surface; and
a support part configured to support the holding part against the substrate.

2. The connection terminal according to claim 1, wherein the support part includes a surface contact part to be surface contact with the one surface of the substrate.

3. The connection terminal according to claim 1, wherein the holding part includes
a pair of clamping parts configured to clamp the holdable part and
a coupling part coupling the pair of clamping parts at a position protruding, toward a side opposite to the one surface, from the other surface.

4. The connection terminal according to claim 3, wherein the holding part includes at least one first cutout portion.

5. The connection terminal according to claim 4, wherein the first cutout portion is formed from one of the pair of clamping parts to another of the pair of clamping parts through the coupling part.

6. The connection terminal according to claim 3, wherein
the pair of clamping parts respectively include a first contact part and a second contact part configured to contact the holdable part,
the support part has a connection part to be connected to the substrate, and
at least one of a first length from the first contact part to the second contact part through at least a part of the clamping part and the coupling part, a second length from the first contact part to an open end of the support part through at least a part of the clamping part and the support part, or a third length from the second contact part to the open end through at least a part of the clamping part and the support part is less than or equal to ⅛ of a wavelength of a frequency supported by the antenna element, or at least one of a fourth length which is a shortest distance from the first contact part to the connection part through at least a part of the clamping part and at least a part of the support part, or a fifth length which is a shortest distance from the second contact part to the connection part through at least a part of the clamping part and at least a part of the support part is less than or equal to 1/16 of the wavelength of the frequency supported by the antenna element.

7. A connection terminal configured to connect an antenna element to a substrate, the connection terminal comprising:
a holding part including a first contact part and a second contact part configured to contact a holdable part of the antenna element with the holdable part being clamped therebetween; and
a support part configured to support the holding part against the substrate, wherein
the support part includes a connection part to be connected to the substrate, and
at least one of a first length from the first contact part to the second contact part through at least a part of the holding part and at least a part of the support part, a second length from the first contact part to an open end of the support part through at least a part of the holding part and the support part, or a third length from the second contact part to the open end is less than or equal to ⅛ of a wavelength of a frequency supported by the antenna element, or at least one of a fourth length from the first contact part to the connection part through at least a part of the holding part and at least a part of the support part, or a fifth length from the second contact part to the connection part through at least a part of the holding part and at least a part of the support part is less than or equal to 1/16 of the wavelength of the frequency supported by the antenna element.

8. An antenna device comprising:
the connection terminal according to claim 1;
the substrate to which the connection terminal is attached;
the antenna element connected to the substrate through the connection terminal; and
a ground portion configured to function as a ground of the antenna element.

9. The antenna device according to claim 8, wherein
the antenna element includes
a first flat plate portion provided so as to face the ground portion and
a second flat plate portion and a third flat plate portion that are provided in a direction from the first flat plate portion toward the ground portion,
the holdable part is provided to at least one of the second flat plate portion or the third flat plate portion,
the first flat plate portion, the second flat plate portion, and the third flat plate portion are connected to one another,
a gap is formed between the first flat plate portion and the second flat plate portion, and
the second flat plate portion includes a second cutout portion continuous with the gap.

10. The antenna device according to claim 8, wherein
at least a part of the antenna element is located outside the substrate in plan view of the substrate, and
at least a part of the antenna element located outside the substrate overlaps with the ground portion in the plan view.

11. An antenna device comprising:
the connection terminal according to claim 7;
the substrate to which the connection terminal is attached;
the antenna element connected to the substrate through the connection terminal; and
a ground portion configured to function as a ground of the antenna element.

12. The antenna device according to claim 11, wherein
the antenna element includes
a first flat plate portion provided so as to face the ground portion and
a second flat plate portion and a third flat plate portion that are provided in a direction from the first flat plate portion toward the ground portion,
the holdable part is provided to at least one of the second flat plate portion or the third flat plate portion,
the first flat plate portion, the second flat plate portion, and the third flat plate portion are connected to one another,
a gap is formed between the first flat plate portion and the second flat plate portion, and
the second flat plate portion includes a second cutout portion continuous with the gap.

13. The antenna device according to claim 11, wherein
at least a part of the antenna element is located outside the substrate in plan view of the substrate, and
at least a part of the antenna element located outside the substrate overlaps with the ground portion in the plan view.
